(19) United States
(12) Patent Application Publication
(10) Pub. No.: US 2017/0294955 A1
(43) Pub. Date: Oct. 12, 2017

(54) RADIO CONTROL DEVICE AND RADIO RELAY DEVICE

(71) Applicant: FUJITSU LIMITED, Kawasaki-shi (JP)

(72) Inventor: Shun Tomioka, Kawasaki (JP)

(73) Assignee: FUJITSU LIMITED, Kawasaki-shi (JP)

(21) Appl. No.: 15/478,396

(22) Filed: Apr. 4, 2017

(30) Foreign Application Priority Data
Apr. 7, 2016 (JP) 2016-077159

(51) Int. Cl. H04B 7/155; H04W 72/12

(52) U.S. Cl. CPC H04B 7/15507; H04W 72/12

(57) ABSTRACT

A radio control device includes, a transmission unit that transmits, to the radio relay device, a first frame which has a plurality of subframes each having a fixed time length, the plurality of subframes including one or more subframes that store respective identifiers of the plurality of radio devices and the radio relay device, a reception unit that receives a second frame which has one or more subframes that store the identifiers of the plurality of radio devices and the radio relay device from the radio relay device, and a detection unit that detects a time difference between a transmission time point of the subframe that stores the identifiers of the respective devices in the first frame and a reception time point of the subframe that stores the identifiers of the respective devices in the second frame received.

### CROSS-REFERENCE TO RELATED APPLICATION

This application is based upon and claims the benefit of priority of the prior Japanese Patent Application No. 2016-077159, filed on Apr. 7, 2016, the entire contents of which are incorporated herein by reference.

### FIELD

The present invention relates to a radio control device and a radio relay device.

### BACKGROUND

A radio communication system realizes radio communication by allowing a base station device and a mobile communication terminal to transmit and receive radio waves. The base station device covers a range between several tens of meters and several kilometers around the base station device as a radio communication area. However, within the area covered by the base station device, a place where radio waves are shielded by a structure such as a building such that radio waves do not easily arrive, or a place where a large number of people use mobile communication terminals simultaneously such that radio waves become temporarily insufficient, are present. In this regard, base station systems in which a baseband unit and a radio unit of a base station device are separated as individual devices, so that the number of only radio units which transmit and receive radio waves can be increased, are becoming increasingly widespread (hereinafter a baseband unit device is referred to as a radio equipment controller (REC) and a radio unit device is referred to as a radio equipment (RE)). The REC and the RE are connected by an optical cable, and the REC controls the timings at which a plurality of REs transmits radio waves.

A relay RE that relays the REC and the plurality of REs is also available. The relay RE performs a process of relaying data transmitted and received between the REC and the RE, in addition to a radio process that the RE performs. When the relay RE is provided, it is possible to decrease the amount of optical cables used in the base station system and to increase the number of REs at a low cost.

The RE and the relay RE subordinate to the REC adjust radio wave transmission timings in a synchronized manner. In order to make the radio wave transmission timings of respective REs identical, the REC, e.g., staggers timings of data transmission to respective REs, or provides instructions on periods taken for standby from when each RE receives data to when each RE transmits radio waves. The REC calculates a time difference between data transmission timings and a waiting period until transmission of radio waves, based on a period (arrival period) it takes for the data transmitted by the REC to arrive in the relay RE and the RE. The REC measures a time difference between the time point at which transmission of a frame to each RE starts and the time point at which reception of a response frame to the transmitted frame starts (hereinafter this time difference is sometimes referred to as a frame transmission/reception time difference) and calculates the arrival period based on the measured time difference.

The REC measures the frame transmission/reception time difference during the start-up of a base station system, for example. During measurement of the frame transmission/reception time difference, the REC executes measurement for each relay RE and each RE by transmitting measurement data to the relay RE and the subordinate RE and receiving response data from the relay RE and the RE having received the measurement data.

Techniques related to transmission of frames are disclosed in Japanese Laid-open Patent Publication No. H8-251129 and International Publication Pamphlet No. WO2010/013332.

### SUMMARY

According to an aspect of the embodiments, a radio control device which is connected to a plurality of radio devices via a radio relay device, the radio control device includes, a transmission unit that transmits, to the radio relay device, a first frame which has a plurality of subframes each having a fixed time length, the plurality of subframes including one or more subframes that store respective identifiers of the plurality of radio devices and the radio relay device, a reception unit that receives a second frame which has one or more subframes that store the identifiers of the plurality of radio devices and the radio relay device from the radio relay device, and a detection unit that detects a time difference between a transmission time point of the subframe that stores the identifiers of the respective devices in the first frame and a reception time point of the subframe that stores the identifiers of the respective devices in the second frame received, wherein the subframe that stores the identifiers of the respective devices, included in the second frame, includes a subframe that stores the identifier of the radio relay device that the radio relay device has inserted in the second frame in response to reception of the subframe that stores the identifier of the radio relay device in the first frame, and a subframe that stores the identifier of the radio device that the radio relay device has inserted in the second frame at a timing corresponding to a reception timing of a subframe that stores the identifier of the radio device in a third frame, the third frame being sent by the radio device to the radio relay device in response to reception of the subframe that stores the identifier of a subject radio device in the first frame, and the third frame having the subframe that stores the identifier of the subject radio device.

An aspect of the present invention provides a REC that shortens a measurement period for a time difference between a time point at which transmission of a frame starts and a time point at which reception of a response frame to the transmitted frame starts in a communication system in which a plurality of REs is connected to a relay RE.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a configuration example of a base station system 10.

FIG. 2 is a diagram illustrating an example in which radio waves are transmitted after the radio control device 100 transmits data.

FIG. 3 is a diagram illustrating a configuration example of the radio control device 100.

FIG. 4 is a diagram illustrating a configuration example of the radio relay device 200.

FIG. 5 is a diagram illustrating a configuration example of the radio device 300.

FIG. 6 is a diagram illustrating an example of a frame configuration.

FIG. 7 is a diagram illustrating an example of a sequence of the frame transmission/reception time difference measurement process.

FIG. 8 is a diagram illustrating an example of a process flow of the measurement request frame transmission process.

FIG. 9 is a diagram illustrating an example of a processing flow of the measurement request frame reception process.

FIG. 10 is a diagram illustrating an example of a processing flow of the measurement request frame transmission process.

FIG. 11 is a diagram illustrating an example of a processing flow of the measurement response frame transmission process.

FIG. 12 is a diagram illustrating an example of a processing flow of the measurement request frame reception process.

FIG. 13 is a diagram illustrating an example of a processing flow of the measurement response frame reception process.

FIG. 14 is a diagram illustrating an example of a time chart of frames transmitted and received between respective devices.

FIG. 15 is a diagram illustrating an example of an arrival period calculation result.

FIG. 16 is a diagram illustrating a configuration example of the base station system 10.

FIG. 17 is a diagram illustrating an example of a subframe used for measuring a frame period.

FIG. 18 is a diagram illustrating an example of a processing flow of the measurement request frame transmission process of the radio relay device 200.

FIG. 19 is a diagram illustrating an example of a processing flow of the measurement response frame transmission process of the radio relay device 200.

FIG. 20 is a diagram illustrating an example of a processing flow of the measurement request frame reception process of the radio device 300.

FIG. 21 is a diagram illustrating an example of transition of route information for each communication route.

FIG. 22 is a diagram illustrating a configuration example of a base station system.

FIG. 23 is a diagram illustrating a configuration example of a base station system.

### DESCRIPTION OF EMBODIMENTS

When many REs are connected to the relay RE, it is necessary to transmit and receive a measurement frame to and from many REs, then the number of measurements increases, and it takes a considerable amount of time until all measurements are completed. For example, in a common public radio interface (CPRI), data is transmitted and received in respective frames and the next frame cannot be transmitted until transmission of a certain frame is completed. Moreover, a transmission period for one frame is determined by the CPRI specifications and it is not possible to shorten the transmission period for a time difference measurement frame having a small data amount. Due to this, in a scheme in which the time difference is measured for respective REs, the larger the number of connected REs, the longer the measurement period.

<Configuration Example of Base Station System>

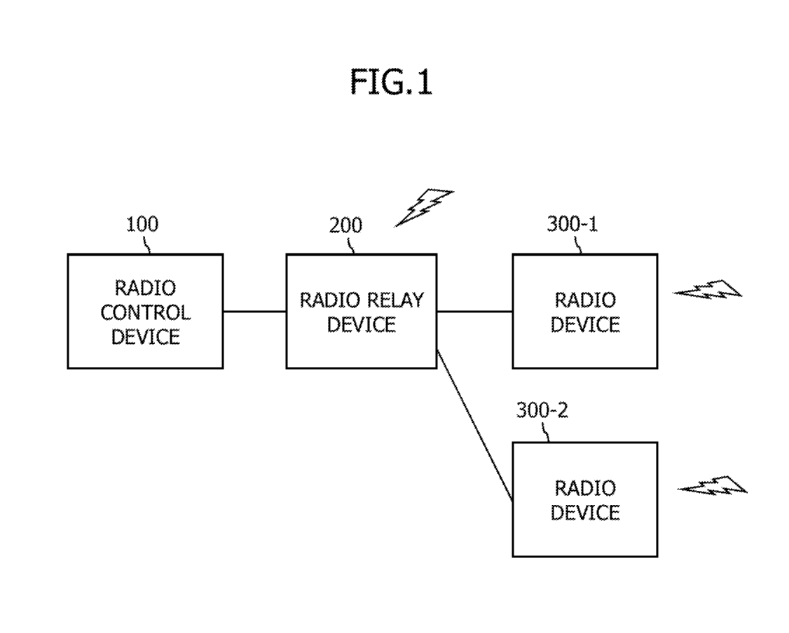

FIG. 1 is a diagram illustrating a configuration example of a base station system 10. The base station system 10 includes a radio control device (for example, a REC) 10, a radio relay device (for example, a relay RE) 200, and radio devices (for example, REs) 300-1 and 300-2. The base station system 10 is a base station device in a radio communication system and is connected wirelessly to a mobile terminal to relay communication between the mobile terminal and a network such as the Internet. For example, when the radio communication system is compatible with long term evolution (LTE) communication specifications, the base station system is an evolved NodeB (eNodeB).

The radio control device 100, the radio relay device 200, and the radio devices 300-1 and 300-2 are connected by an optical cable, for example, and communication between the devices follows the common public radio interface (CPRI) specifications. In the CPRI, communication is performed by transmitting and receiving a frame having a fixed time length.

The radio control device 100 controls the timings at which the radio relay device 200 and the radio devices 300-1 and 300-2 transmit radio waves. When the radio relay device 200 and the radio devices 300-1 and 300-2 transmit radio waves at the same timings, the mobile terminal can receive radio waves transmitted by the respective devices.

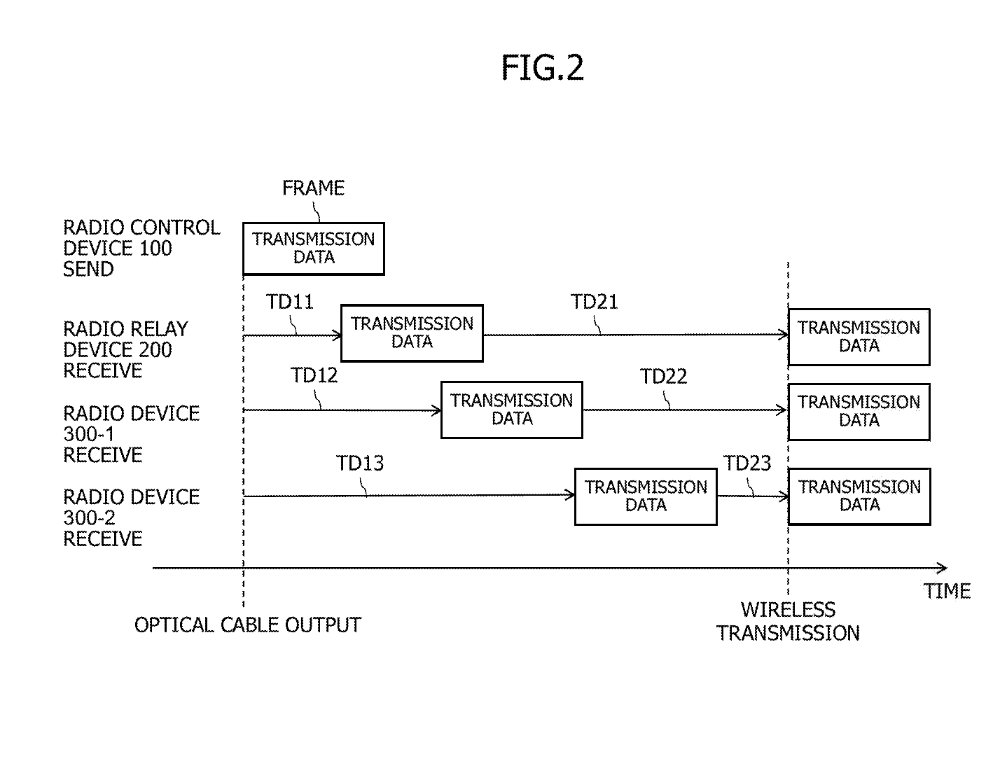

FIG. 2 is a diagram illustrating an example in which radio waves are transmitted after the radio control device 100 transmits data. The radio control device 100 transmits transmission data to the radio relay device 200 and the radio devices 300-1 and 300-2. The radio relay device 200 and the radio devices 300-1 and 300-2 receive transmission data after the elapse of periods TD11, TD12, and TD13, respectively. Even when transmission data is received, the radio relay device 200 and the radio devices 300-1 and 300-2 do not transmit radio waves immediately but transmit radio waves after the elapse of periods TD21, TD22, and TD23, respectively. By doing so, the radio relay device 200 and the radio devices 300-1 and 300-2 can transmit radio waves at the same timing. The radio control device 100 calculates the periods TD21 to TD23 of the respective devices and notifies the calculated periods to the respective devices to thereby execute control of synchronizing the radio wave transmission timings of the respective devices. The radio control device 100 calculates the periods TD11 to TD13 which are the arrival periods of the respective devices in order to calculate the periods TD21 to TD23 of the respective devices.

The radio control device 100 measures a frame transmission/reception time difference to calculate the arrival period of each device. For example, the frame transmission/reception time difference may be measured for each radio relay device and each radio device to be connected (hereinafter, this method is referred to as a device-based measurement method). When the frame transmission/reception time difference is measured in the base station system illustrated in FIG. 1 using the device-based measurement method, first, a measurement frame is transmitted to the radio device 300-1. The radio device 300-1 having received the measurement frame via the radio relay device 200 transmits a response frame to the radio control device 100. The radio control device 100 receives a response frame via the radio relay device 200. The radio control device 100 detects a frame transmission/reception time difference based on a period elapsed until the response frame is received after the measurement frame is transmitted. Subsequently, the radio control device 100 repeats the same procedure to measure the frame transmission/reception time differences of all devices connected thereto to calculate the arrival periods of the respective devices.

As described above, in the device-based measurement method, it takes a considerable amount of time to calculate the arrival periods of all devices as the number of radio devices connected to the radio relay device increases. In the CPRI, the period taken to transmit (or receive) one frame is fixed to 10 msec, for example, and at least 20 msec is taken to transmit and receive one frame. Due to this, when all devices are measured, a period obtained by multiplying the period taken to transmit and receive one frame and the number of connected devices is taken.

In a frame transmission/reception time difference measurement method according to a first embodiment to be described later, the radio control device 100 perform measurement on all radio devices connected to the radio relay device by transmitting one frame and receiving one frame. Therefore, it is possible to measure the frame transmission/reception time difference in a short period as compared to the device-based measurement method.

Calculation of the arrival period of each device is executed until general communication starts after layer-1 synchronization of CPRI in the optical cable that connects the respective devices is established, for example. The state in which layer-1 synchronization of CPRI is established is a state in which the frame transmission/reception cycle is identical between a transmission-side device and a reception-side device, for example. Moreover, calculation of the arrival period of each device is executed until general communication restarts after layer-1 synchronization is established again after the layer-1 synchronization of CPRI is lost due to fault or the like in the optical cable or each device.

### First Embodiment

First, a first embodiment will be described.

In the first embodiment, a radio control device transmits a measurement request frame (also referred to as a first frame) which is a frame having a plurality of subframes having a fixed time length and has a subframe that stores the identifiers of a plurality of radio devices and a radio relay device to the radio relay device.

The radio relay device receives the measurement request frame and transmits the measurement request frame to the plurality of radio devices. Furthermore, in response to reception of the subframe that stores the identifier of the radio relay device, included in the measurement request frame, the radio relay device sends a measurement response frame (also referred to as a second frame) having the subframe that stores the identifier of the radio relay device to the radio control device.

In response to reception of the subframe that stores the identifier of the radio device, included in the measurement request frame, the radio device sends a measurement response frame (also referred to as a third frame) having a subframe that stores the identifier of the subject radio device to the radio relay device.

The radio relay device inserts the subframe that stores the identifier of the radio device to the measurement response frame (the second frame) at a timing corresponding to the reception timing of the subframe that stores the identifier of the radio device, included in the measurement response frame (the third frame).

The radio control device detects a time difference (frame transmission/reception time difference) between the transmission time point of the subframe that stores the identifier of each device, included in the measurement request frame and the reception time point of the subframe that stores the identifier of each device, included in the received measurement response frame (the second frame).

<Configuration Example of Radio Control Device>

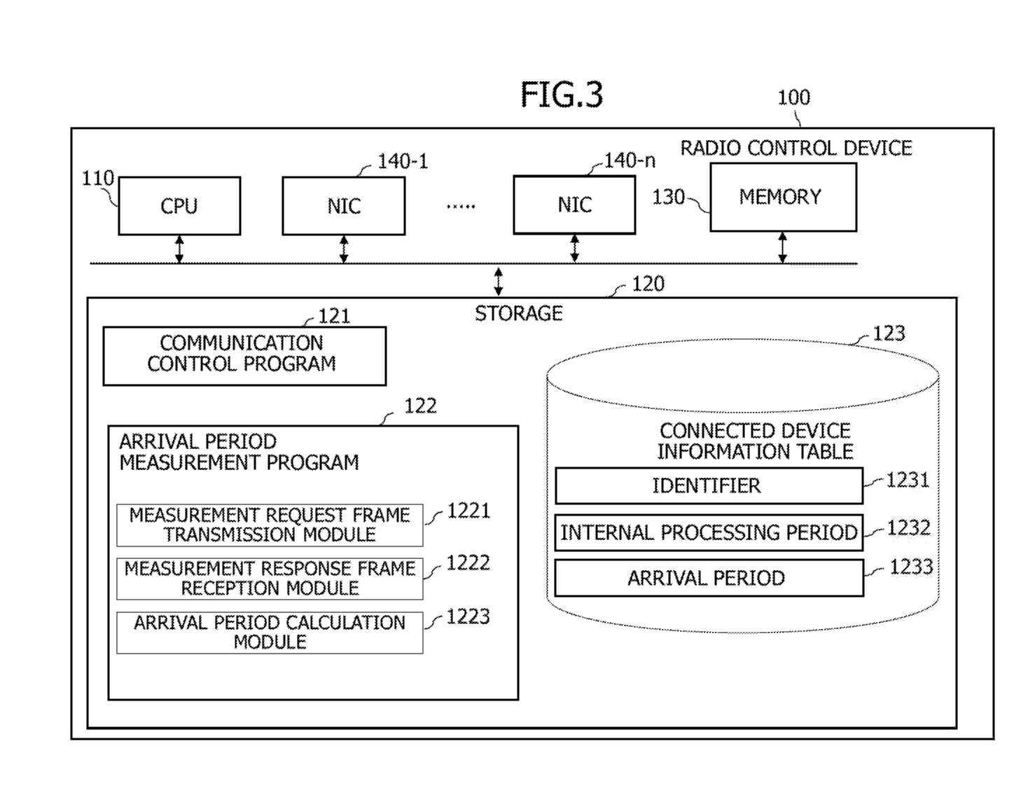

FIG. 3 is a diagram illustrating a configuration example of the radio control device 100.

The radio control device 100 includes a central processing unit (CPU) 110, a storage 120, a memory 130, and network interface cards (NICs) 140-1 to 140-n. The radio control device 100 is a device (for example, a REC) that performs the process of a baseband unit of a base station device and controls the timings at which a radio device or a radio relay device to be connected thereto transmits radio waves.

The storage 120 is an auxiliary storage device that stores a program and data. The storage 120 stores a communication control program 121, an arrival period measurement program 122, and a connected device information table 123.

The connected device information table 123 is a table that stores information on devices included in the base station system 10. The information element stored in the connected device information table 123 includes an identifier 1231, an internal processing period 1232, and an arrival period 1233. The respective information elements are stored for each device.

The identifier 1231 is identification information that uniquely identifies devices. The identification information is, for example, a media access control (MAC) address of a device and a numerical value that a system administrator sets so as not to overlap within the system.

The internal processing period 1232 is the time taken for each device to perform a process of transmitting a measurement response frame. The measurement response frame is a frame indicating a response to a measurement request of the radio control device 100. The internal processing period 1232 is the time used for calculating an arrival period of each device. The radio control device 100 may acquire the internal processing period 1232 by receiving a measurement result obtained when each device transmits the measurement response frame, but the period may be another measured or calculated fixed value.

The arrival period 1233 is an arrival period of each device. The arrival period 1233 is updated when the radio control device 100 calculates the arrival period of each device.

A connection relation of respective devices may be stored in the connected device information table 123. For example, in the case of FIG. 1, a connection relation to be stored indicates that the radio relay device 200 is connected to the radio control device 100 and the radio devices 300-1 and 300-2, and while the radio devices 300-1 and 300-2 are connected to the radio relay device 200, are not directly connected to the radio control device 100.

The memory 130 is an area on which the program stored in the storage 120 is loaded. Moreover, the memory 130 may be used as an area in which a program stores data.

The NICs 140-1 to 140-n are devices that are connected to the radio relay device, the radio device, or other communication devices wirelessly or via cables to perform communication. The NICs 140-1 to 140-n may be connected to other devices via a hub or a switch.

The CPU 110 is a processor that loads the program stored in the storage 120 on the memory 130 and executes the loaded program to realize respective processes.

The CPU 110 realizes a function of a communication control unit by executing the communication control program 121. The communication control unit transmits the data of the radio waves transmitted by the radio relay device 200 and the radio devices 300-1 and 300-2 and receives data acquired by the radio relay device 200 and the radio devices 300-1 and 300-2 receiving the radio waves. Moreover, the communication control unit controls the transmission timing of the radio waves transmitted by each device.

The CPU 110 realizes an arrival period measurement process by executing the arrival period measurement program 122 and respective modules included in the program. The arrival period measurement program 122 includes a measurement request frame transmission module 1221, a measurement response frame reception module 1222, and an arrival period calculation module 1223. The arrival period measurement process is a process of measuring frame transmission/reception time differences of the radio relay device 200 and the radio devices 300-1 and 300-2 and calculating an arrival period of each device from the detected frame transmission/reception time difference.

The CPU 110 realizes a function of a transmission unit by executing the measurement request frame transmission module 1221. When an arrival period measurement event occurs, the transmission unit generates a frame (hereinafter referred to as a measurement request frame) for requesting the radio relay device 200 and the radio devices 300-1 and 300-2 to measure a frame transmission/reception time difference and transmits the measurement request frame to the radio relay device 200 and the radio devices 300-1 and 300-2. The measurement request frame is a frame having a subframe that stores the identifiers of the radio relay device 200 and the radio devices 300-1 and 300-2 which are measurement targets.

The CPU 110 realizes a function of a reception unit by executing the measurement response frame reception module 1222. Upon receiving the measurement response frame, the reception unit performs an arrival period measurement process to be described later.

The CPU 110 realizes a function of a detection unit by executing the arrival period calculation module 1223. When the reception unit receives the measurement response frame, the detection unit measures the frame transmission/reception time difference of each of the respective measurement target devices and calculates an arrival period based on the frame transmission/reception time difference of each device detected from the measurement result.

<Configuration Example of Radio Relay Device>

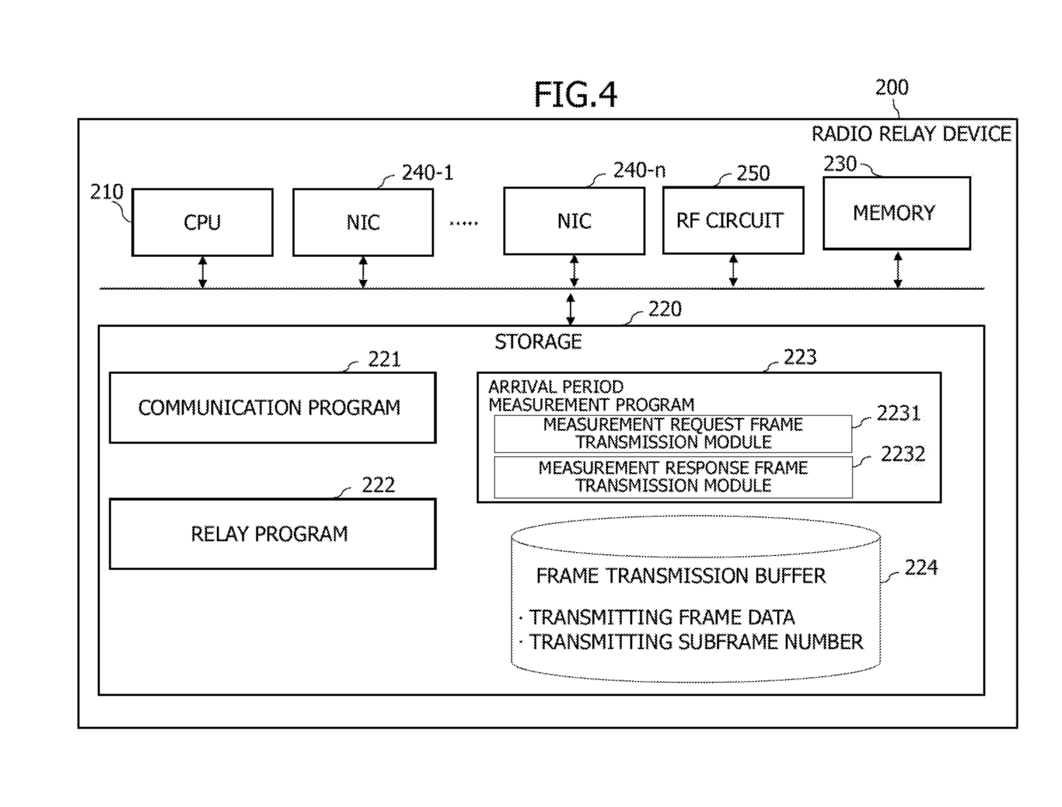

FIG. 4 is a diagram illustrating a configuration example of the radio relay device 200.

The radio relay device 200 includes a CPU 210, a storage 220, a memory 230, NICs 240-1 to 240-n, and a radio frequency (RF) circuit 250. The radio relay device 200 is a device (for example, a relay RE or a network RE) that performs a process of the radio unit of the base station device and relays the frames transmitted and received between the radio device and the radio control device connected thereto.

The storage 220 is an auxiliary storage device that stores a program or data. The storage 220 stores a communication program 221, a relay program 222, an arrival period measurement program 223, and a frame transmission buffer 224.

The frame transmission buffer 224 is a buffer that stores a measurement response frame transmitted to the radio control device 100. The frame transmission buffer 224 includes transmitting frame data 2241 and a transmitting subframe number 2242. The transmitting frame data 2241 is the data of a measurement response frame to be transmitted. The transmitting subframe number 2242 is the number of a subframe which is being transmitted currently. That is, the transmitting subframe number 2242 is information indicating which subframe is currently written on a communication route for transmission to the radio control device 100. A subframe of which the number is smaller than the transmitting subframe number is a subframe which has been written on the communication route and has been transmitted in the radio relay device 200. On the other hand, a subframe of which the number is larger than the transmitting subframe number is a non-transmitted subframe.

The memory 230 is an area on which the program stored in the storage 220 is loaded. Moreover, the memory 230 may be used as an area in which a program stores data.

The NICs 240-1 to 240-n are devices that are connected to other devices wirelessly or via cables to perform communication. The NICs 240-1 to 240-n may be connected to other devices via a hub or a switch.

The RF circuit 250 is a device that realizes transmission and reception of radio waves via an antenna. The RF circuit 250 wirelessly communicates with a mobile terminal device present in a communication area, for example.

The CPU 210 is a processor that loads the program stored in the storage 220 on the memory 230 and executes the loaded program to realize respective processes.

The CPU 210 realizes a function of a communication unit by executing the communication program 221. The communication unit transmits and received frames to and from the radio control device 100. Moreover, the communication unit transmits data included in the frame received from the radio control device 100 as radio waves and transmits the data included in the radio waves received from a mobile terminal device to the radio control device 100 by inserting the data to a frame.

The CPU 210 realizes a function of a relay unit by executing the relay program 222. The relay unit relays frames transmitted and received between the radio control device 100 and the radio devices 300-1 and 300-2. The relay unit relays a received frame to a destination device when the destination of the frame is not a subject device.

The CPU 210 realizes an arrival period measurement process by executing the arrival period measurement program 223 and respective modules included in the program. The arrival period measurement program 223 includes a measurement request frame transmission module 2231 and a measurement response frame transmission module 2232. The arrival period measurement process is a process of receiving a measurement request frame transmitted in the process of the radio control device 100 measuring the arrival period of each device and receiving a measurement response frame transmitted by the radio device 300.

The CPU 210 realizes a function of a transmission unit by executing the measurement request frame transmission module 2231. Upon receiving a measurement request frame from the radio control device 100, the transmission unit transmits the received measurement request frame to the radio devices 300-1 and 300-2 which are all radio devices connected thereto. Moreover, when the radio relay device is connected to another radio relay device, the transmission unit also transmits a measurement request frame to the other radio relay device.

The CPU 210 realizes a function of a responding unit by executing the measurement response frame transmission module 2232. In response to reception of the subframe that stores the identifier of the subject device, included in the measurement request frame received from the radio control device 100, the responding unit sends the measurement response frame including the subframe that stores the identifier of the subject device to the radio control device 100. Moreover, upon receiving the measurement response frame from the radio devices 300-1 and 300-2, the responding unit inserts the subframe that stores the identifiers of the radio devices 300-1 and 300-2 to the measurement response frame being transmitted at a timing corresponding to the reception timing of the subframe that stores the identifiers of the radio devices 300-1 and 300-2, included in the measurement response frame. The timing corresponding to the reception timing is a timing at which the radio relay device 200 transmits a subframe transmitted subsequently to the subframe being transmitted when the subframe is received, for example.

<Configuration Example of Radio Device>

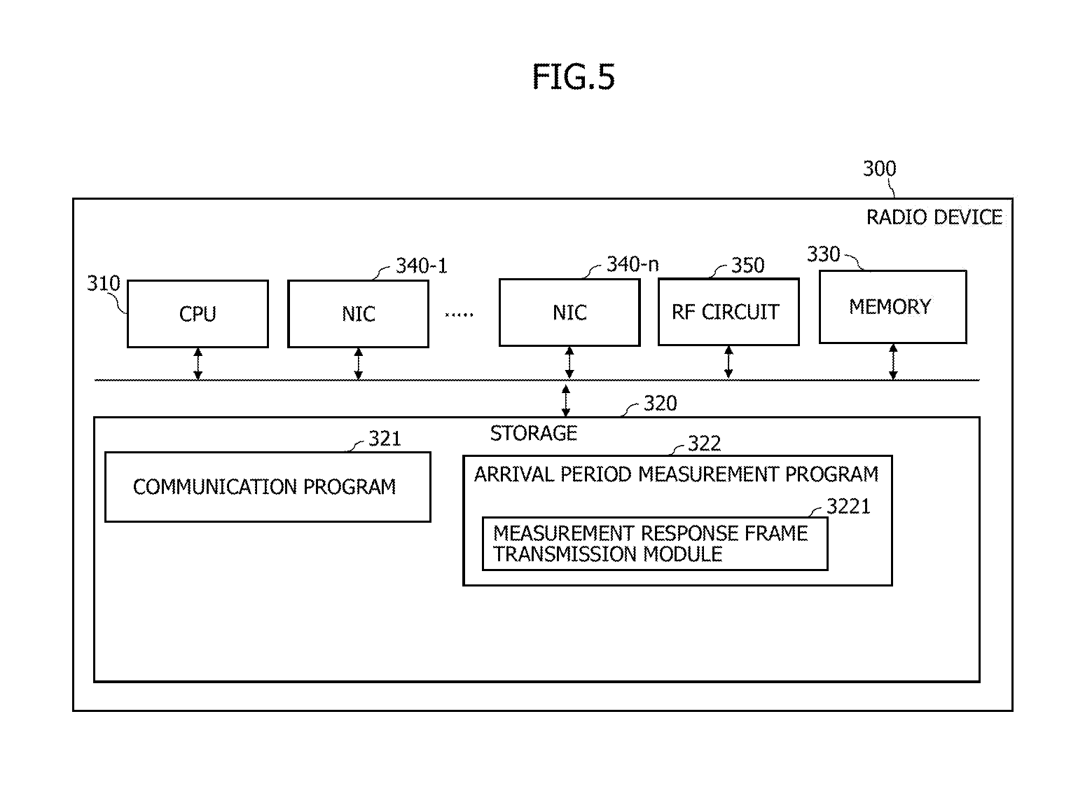

FIG. 5 is a diagram illustrating a configuration example of the radio device 300.

The radio device 300 includes a CPU 310, a storage 320, a memory 330, NICs 340-1 to 340-n, and a RF circuit 350. The radio device 300 is a device (for example, a RE) that performs the process of the radio unit of the base station device.

The storage 320 is an auxiliary storage device that stores a program or data. The storage 320 stores a communication program 321 and an arrival period measurement program 322.

The memory 330 is an area on which a program stored in the storage 320 is loaded. Moreover, the memory 330 may be used as an area in which a program stores data.

The NICs 340-1 to 340-n are devices that are connected to the other devices wirelessly or via cables to perform communication. The NICs 340-1 to 340-n may be connected to the other devices via a hub or a switch.

The RF circuit 350 is a device that transmits and receives radio waves via an antenna. The RF circuit 350 wirelessly communicates with a mobile terminal device present in a communication area, for example.

The CPU 310 is a processor that loads the program stored in the storage 320 on the memory 330 and executes the loaded program to realize respective processes.

The CPU 310 constructs a communication unit to realize the function of the communication unit by executing the communication program 321. The communication unit transmits and receives frames to and from the radio control device 100. Moreover, the communication unit receives data included in a frame received from the radio control device 100 as radio waves and transmits the data included in the radio waves received from the measurement request frame transmission module to the radio control device 100 by inserting the data to a frame.

The CPU 310 realizes an arrival period measurement process by executing the arrival period measurement program 322 and respective modules included in the program. The arrival period measurement program 322 includes a measurement response frame transmission module 3221. The arrival period measurement process is a process of receiving a measurement request frame transmitted in a process of the radio control device 100 measuring the arrival period of each device.

The CPU 310 constructs a reception unit and a transmission unit to realize the functions of the reception unit and the transmission unit by executing the measurement response frame transmission module 3221. The reception unit receives a measurement request frame from the radio control device 100. In response to reception of the subframe that stores the identifier of the subject device, included in the measurement request frame, the transmission unit sends the measurement response frame having the subframe that stores the identifier of the subject device to the radio control device 100.

<Frame Transmission/Reception Time Difference Measurement Process>

Next, a frame transmission/reception time difference measurement process will be described. In the frame transmission/reception time difference measurement process, a frame transmission/reception time difference is measured using frames used for communication between respective devices.

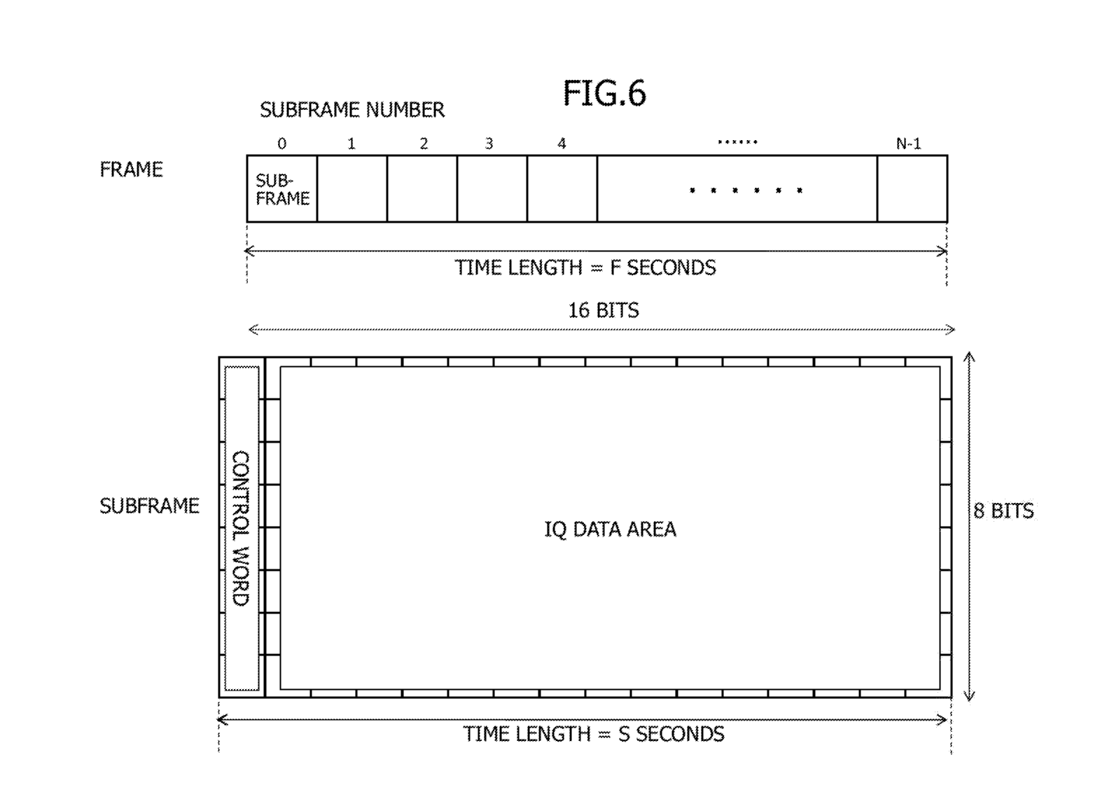

FIG. 6 is a diagram illustrating an example of a frame configuration. Each device performs communication using frames. The time length of the frame is determined by the specifications of CPRI or the like, for example. In FIG. 6, the time length of a frame is F seconds and it takes F seconds to transmit or receive one frame. Moreover, a frame has a plurality of subframes of a fixed time length (S seconds in FIG. 6). In FIG. 6, a frame has N subframes of the subframe numbers 0 to N−1 indicating the number from the start within the frame. Information (not illustrated) (for example, a SYNC byte) indicating the start of a frame is included in the start of the frame.

A subframe has a control word area and an inphase/quadrature (IQ) data area. A data amount and a time length of the subframe are determined by the specifications of CPRI or the like, for example. In FIG. 6, the data amount of a subframe is 128 bits (8×16). The control word area is an area of which the use is determined by the specifications of CPRI or the like, for example. The IQ data area is an area in which data used for measuring the frame transmission/reception time difference, data used for general communication, and the like are stored, for example. In a subframe used for measuring the frame transmission/reception time difference, the identifier of each device is stored in the IQ data area. The IQ data area may store a plurality of identifiers. Hereinafter, storing data in the IQ data area will be expressed as storing data in a subframe.

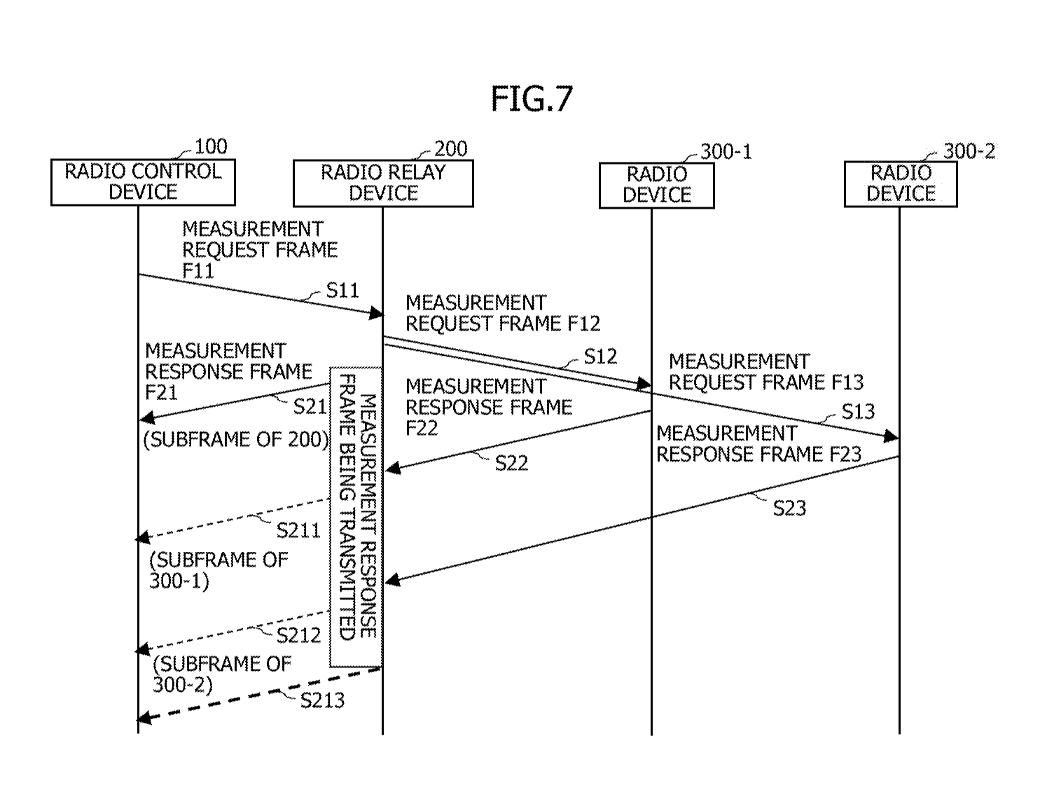

FIG. 7 is a diagram illustrating an example of a sequence of the frame transmission/reception time difference measurement process. When an arrival period measurement event occurs, the radio control device 100 executes a measurement request frame transmission process of transmitting a measurement request frame F11 (S11).

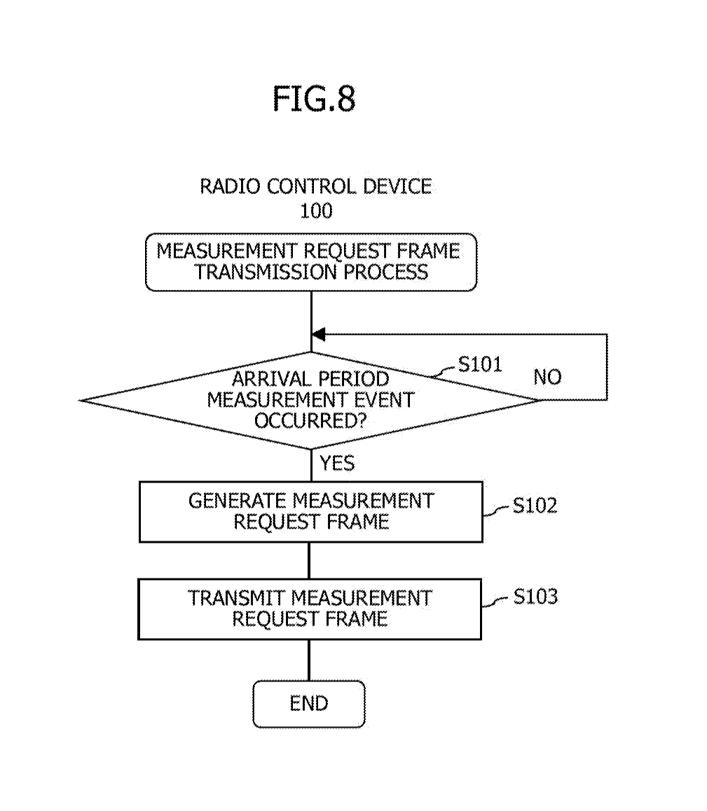

FIG. 8 is a diagram illustrating an example of a process flow of the measurement request frame transmission process. When an arrival period measurement event occurs (S101: Yes), the radio control device 100 generates a measurement request frame (S102). The arrival period measurement event occurs, for example, when the layer-1 synchronization of CPRI is established and when the loss of the layer-1 synchronization of CPRI is resolved and the layer-1 synchronization is established again.

In a measurement request frame generation process (S102), the radio control device 100 reads the identifiers of the radio relay device 200 and the radio devices 300-1 and 300-2 stored in the connected device information table 123. The radio control device 100 stores the identifier of the radio relay device 200 in a subframe (hereinafter referred to as subframe 0) of the subframe number 1 and stores the identifiers of the radio devices 300-1 and 300-2 in subframes 1 and 2. The radio control device 100 transmits the generated measurement request frame to the radio relay device 200 (S103).

Returning to FIG. 7, upon receiving the measurement request frame F11 (S11), the radio relay device 200 executes a measurement request frame reception process.

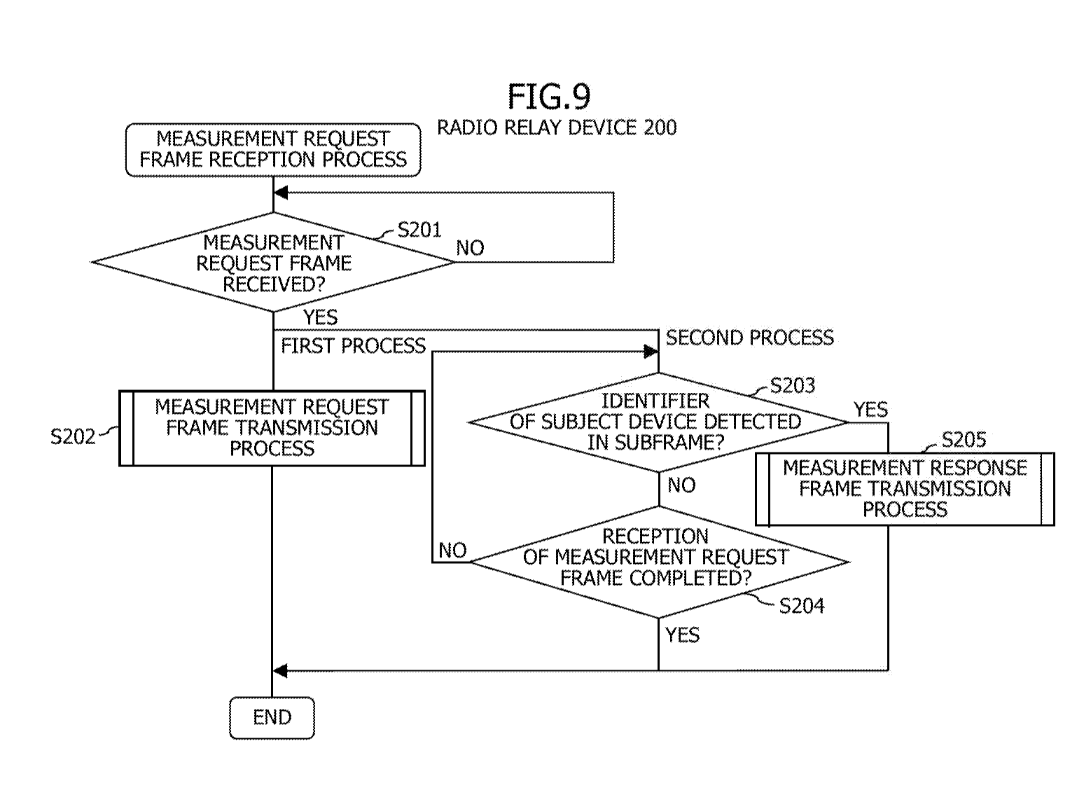

FIG. 9 is a diagram illustrating an example of a processing flow of the measurement request frame reception process. Upon receiving the measurement request frame (S201: Yes), the radio relay device 200 executes first and second processes in parallel.

In the first process, a measurement request frame transmission process (S202) is performed.

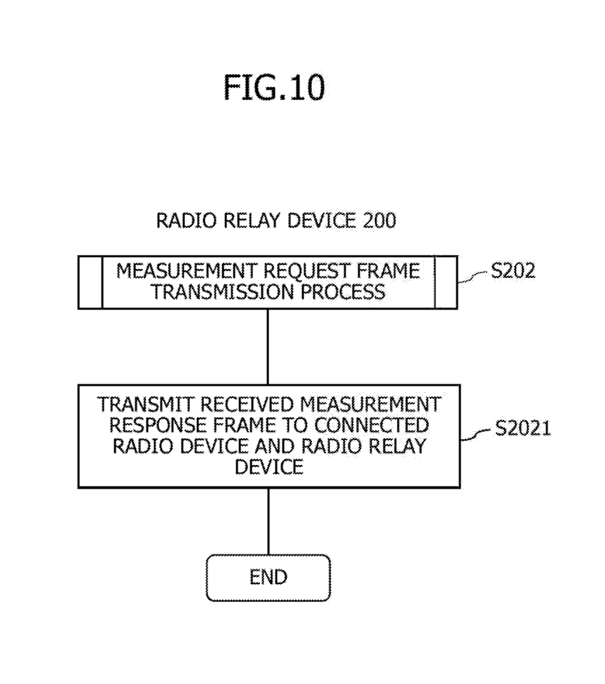

FIG. 10 is a diagram illustrating an example of a processing flow of the measurement request frame transmission process. The radio relay device 200 transmits the received measurement request frame to the radio relay device and the radio device connected thereto (S2021). In the measurement request frame transmission process, when a subframe is received, the received subframe is transmitted to each device.

Returning to FIG. 9, in the second process, it is detected whether the identifier of the subject device is present in the subframe included in the received measurement request frame (S203). When the identifier is not detected (S203: No), the process (S203) of detecting the identifier of the subject device is continued until reception of the measurement request frame is completed (S204: Yes). Upon detecting the identifier of the subject device (S203: Yes), the radio relay device 200 performs a measurement response frame transmission process (S205).

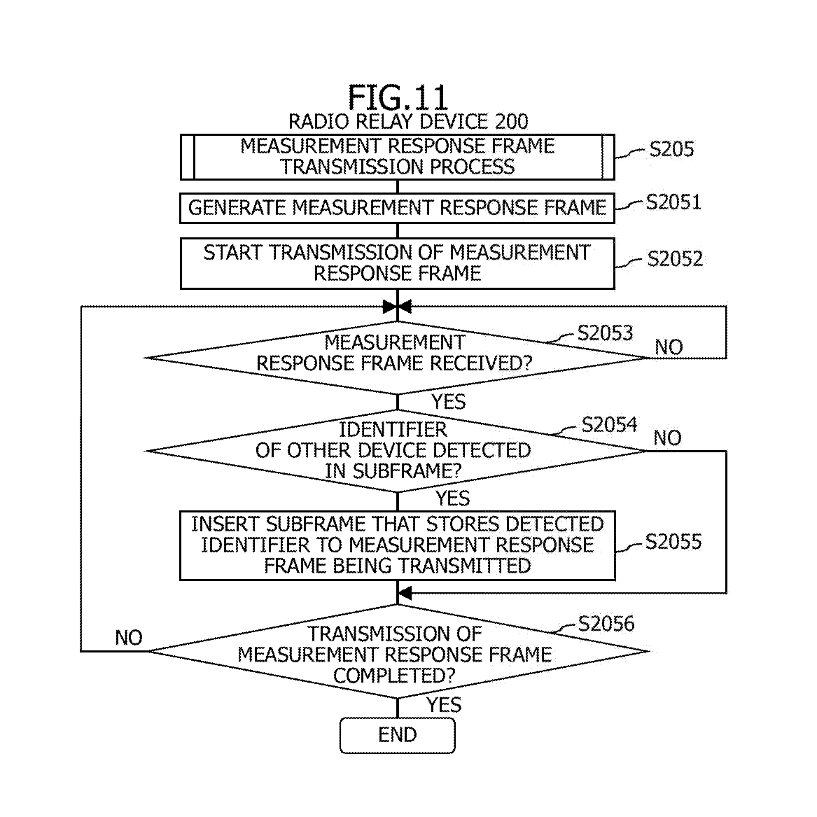

FIG. 11 is a diagram illustrating an example of a processing flow of the measurement response frame transmission process. The radio relay device 200 generates a measurement response frame (S2051). The measurement response frame includes a subframe that stores the identifier of the subject device. The radio relay device 200 starts transmitting the measurement response frame (S2052). Moreover, the radio relay device 200 waits for reception of the measurement response frames from the radio relay device and the radio device connected thereto until transmission of the measurement response frame of which the transmission has been started is completed (S2053). The processes subsequent to FIG. 11 will be described in the process upon reception (S22) of the measurement response frame F22 in the sequence of FIG. 7.

Returning to FIG. 7, the radio relay device 200 executes the measurement response frame transmission process and transmits the measurement request frames F12 and F13 to the radio devices 300-1 and 300-2, respectively (S12 and S13). Moreover, the radio relay device 200 executes the measurement response frame transmission process and starts transmitting the measurement response frame F21 to the radio control device 100 (S21). The identifier of the radio relay device 200 is stored in the subframe at the start of the measurement response frame F21, and the radio control device 100 receives the subframe that stores the identifier of the radio relay device 200 by receiving the measurement response frame F21.

Upon receiving the measurement request frame F12 (S12), the radio device 300-1 performs the measurement request frame reception process.

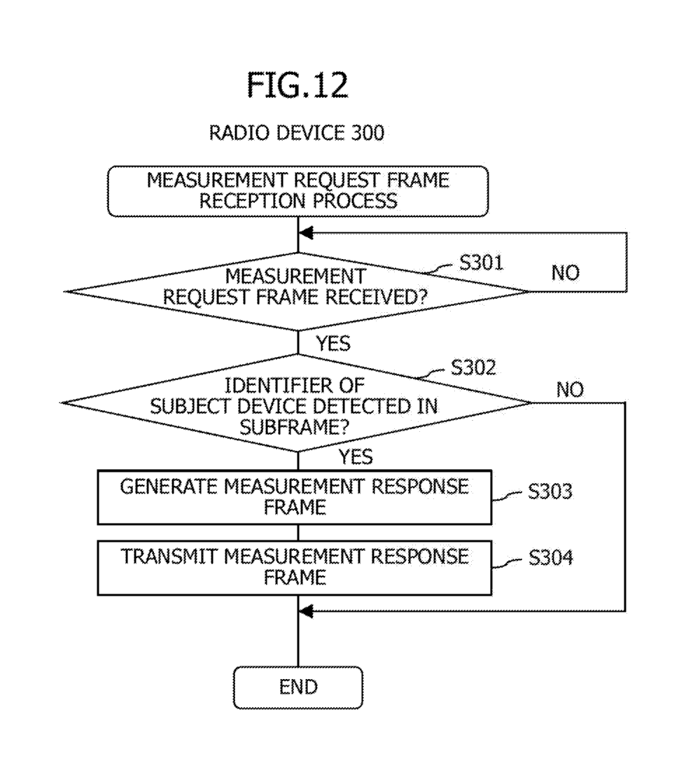

FIG. 12 is a diagram illustrating an example of a processing flow of the measurement request frame reception process. Upon receiving the measurement request frame (S301: Yes), the radio device 300 searches for the identifier of the subject device in the subframe (S302). Upon detecting the identifier of the subject device (S302: Yes), the radio device 300 generates a measurement response frame (S303). The measurement response frame includes a subframe that stores the identifier of the subject device. The radio device 300 transmits the generated measurement response frame to the radio control device 100 (S304).

Returning to FIG. 7, the radio device 300-1 executes the measurement request frame reception process and transmits the measurement response frame F22 (S22). Similarly, the radio device 300-2 receives the measurement request frame F13 (S13), executes the measurement request frame reception process, and transmits the measurement response frame F23 (S23).

Upon receiving the measurement response frame F22 from the radio device 300-1 (S22), the radio relay device 200 continuously executes the measurement response frame transmission process in which it is waited for reception of the measurement response frame.

Returning to FIG. 11, upon receiving the measurement response frame (S2053: Yes), the radio relay device 200 searches whether the identifier of the other device is present in the subframe (S2054). Upon detecting the identifier (S2054: Yes), the radio relay device 200 inserts the subframe that stores the detected identifier to the measurement response frame being transmitted to the radio control device (S2055). The position to which the subframe is inserted is a position of a subframe transmitted subsequently to a subframe being transmitted when the radio relay device detects the identifier. That is, the subframe is inserted to a position of the subframe having a subframe number next to the subframe number of the subframe being transmitted. When a plurality of subframes that store the identifier of the other device are present in the received measurement response frame, upon receiving the subframe, the measurement response frame in which the subframe is being transmitted is inserted at a timing corresponding to the reception timing of the subframe. Moreover, it is waited for reception of another measurement response frame until transmission of the measurement response frame is completed, and when transmission of the measurement response frame is completed (S2056: Yes), the process ends.

Returning to FIG. 7, the radio relay device 200 executes the measurement response frame transmission process and inserts the subframe that stores the identifier of the radio device 300-1, included in the measurement response frame F22 to the measurement response frame F21 being transmitted. The radio control device 100 receives the subframe that stores the identifier of the radio device 300-1 by receiving the measurement response frame F21 (S211). Similarly, the radio relay device 200 executes the measurement response frame transmission process and inserts the subframe that stores the identifier of the radio device 300-2, included in the measurement response frame F23 to the measurement response frame F21 being transmitted. The radio control device 100 receives the subframe that stores the identifier of the radio device 300-2 by receiving the measurement response frame F21 (S212). The radio relay device 200 completes transmission of the measurement response frame (S213) and ends the process. By doing so, the subframe that stores the identifiers of the radio devices 300-1 and 300-2 is included in the measurement response frame F21 and is transmitted to the radio control device 100.

Upon receiving the measurement response frame F21 (S21), the radio control device 100 performs a measurement response frame reception process.

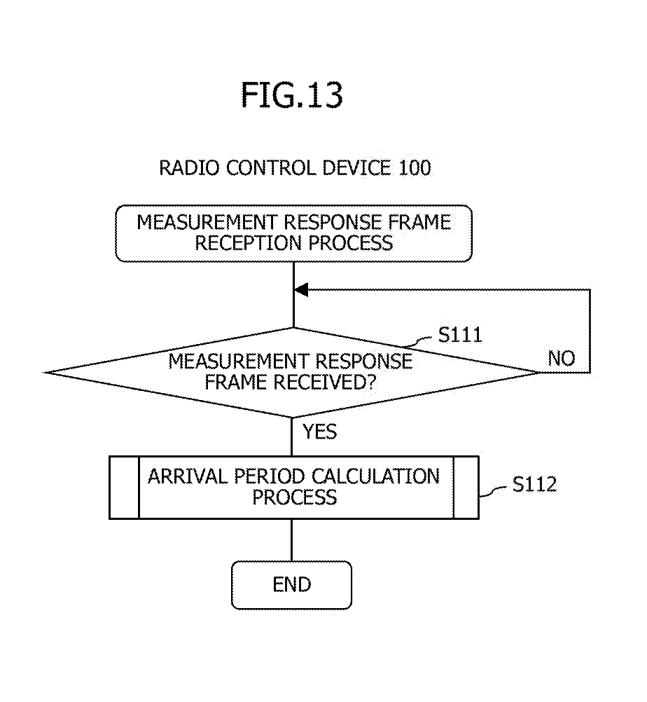

FIG. 13 is a diagram illustrating an example of a processing flow of the measurement response frame reception process. Upon receiving the measurement response frame (S111: Yes), the radio control device 100 executes the arrival period measurement process (S112). In the arrival period measurement process, the radio control device 100 detects the frame transmission/reception time difference of each device. The arrival period measurement process will be described in an arrival period measurement method to be described later.

A process of searching for the subframe that stores the identifier of the subject device or the other device is performed in S203 in FIG. 9, S2054 in FIG. 11, S302 in FIG. 12, and the like. In the embodiment, each device stores the identifiers of the subject device and the other device, and a search process is performed by comparing the searched subframe with the stored identifier.

However, a fixed subframe number may be allocated to each device such that the radio relay device 200 has subframe number 0 and the radio device 300-1 has subframe number 1, for example, and the allocated number may be transmitted to each device as a message, or may be set in a configuration file, for example.

The subframe number that the subject device sends may be calculated by a common calculation formula stored in advance in each device using the number (number of hops) of radio relay devices that relay a frame until the frame arrives in the radio device, the port number connected to the connected radio relay device, and the like, for example.

When a fixed subframe number is allocated or the subframe number is calculated by a common calculation formula, it is also possible for each device not to search for the identifier in the subframe. Upon receiving a subframe of the subframe number corresponding to the subject device, each device inserts the received subframe to the start of the measurement response frame and transmits the measurement response frame. Upon receiving the measurement response frame from the radio device, the radio relay device inserts the subframe at the start of the measurement response frame to the measurement response frame being transmitted. The radio control device can identify a device to which the received subframe corresponds by storing a simple numerical value in the corresponding subframe as the identifier of each device and storing a list of correspondences between the stored numerical values and the devices. By doing so, each device can send a response to the subframe without searching for the identifier, and the processing load decreases.

<Frame Transmission/Reception Time Chart>

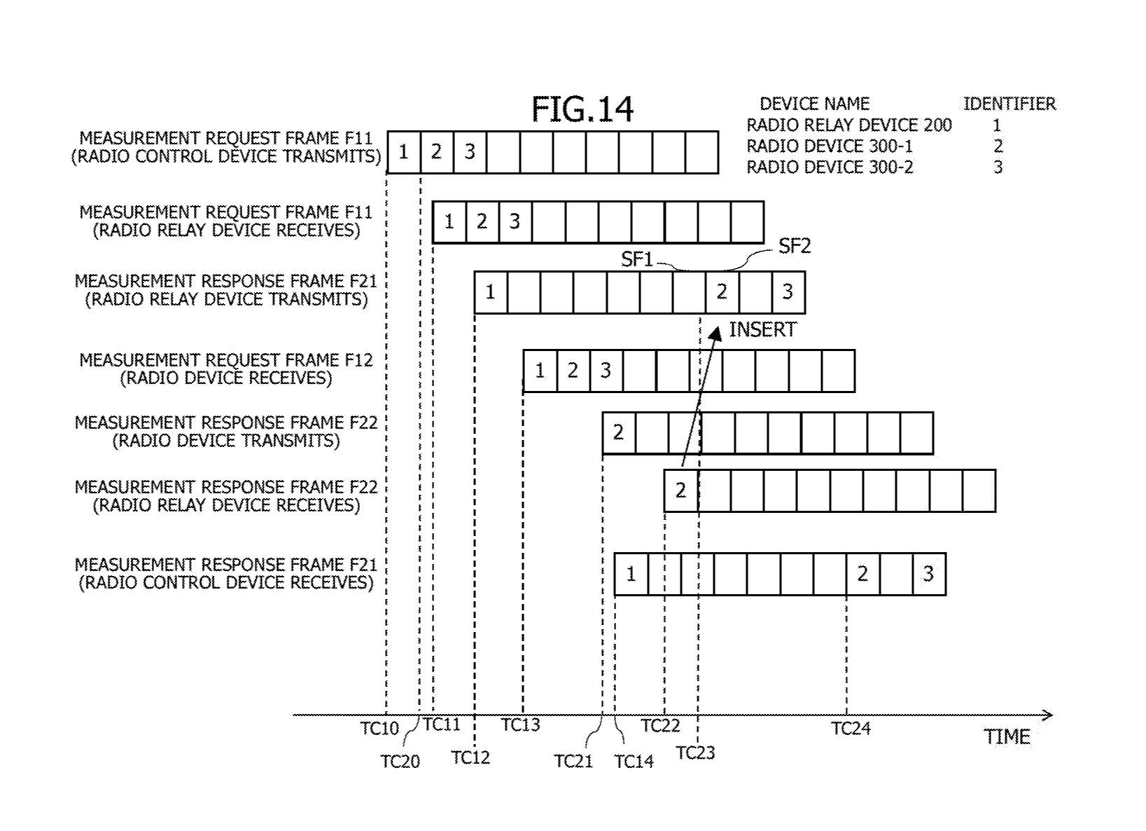

FIG. 14 is a diagram illustrating an example of a time chart of frames transmitted and received between respective devices. The timings at which each device transmits and receives frames and the content of the frames will be described with reference to FIG. 14. In FIG. 14, the identifier of the radio relay device 200 is 1, the identifier of the radio device 300-1 is 2, and the identifier of the radio device 300-2 is 3. Moreover, the same process as the radio device 300-1 is performed for the radio device 300-2, and a process of inserting the identifier of the radio device 300-2 to the measurement response frame is not illustrated in FIG. 14.

The radio control device 100 stores 1 in subframe 0, and 2 in subframe 1, and transmits the measurement request frame F11 at time TC10.

The radio relay device 200 receives the measurement request frame F11 at time TC11 after the elapse of a delay in an optical cable. The radio relay device 200 transmits the received measurement request frame F11 to the radio device 300-1. Furthermore, the radio relay device 200 generates the measurement response frame F21 in which the identifier 1 of the subject device is stored in the subframe 0. After the elapse of an internal processing period taken for preparation of transmission such as generation of frames after the measurement request frame F11 is received, transmission of the measurement response frame F21 to the radio control device 100 starts at time TC12.

The radio device 300-1 receives the measurement request frame F12 transmitted at time TC13 after the elapse of a delay in an optical cable after the radio relay device 200 receives the measurement request frame and transmits the measurement request frame to the radio device 300-1. The radio device 300-1 receives the subframe that stores the identifier 2 after the elapse of a time length of one subframe from time TC13 and generates the measurement response frame 22 including the subframe that stores the identifier 2. The radio device 300-1 transmits the measurement response frame 22 at time TC21 after the elapse of an internal processing period taken for preparation of transmission such as generation of frames from reception of the subframe that stores the identifier 2.

The radio relay device 200 receives the measurement response frame F22 at time TC22 after the elapse of a delay in the optical cable from time TC21. Moreover, the radio relay device 200 completes reception of the subframe that stores the identifier 2 included in the measurement response frame F2 at time TC23. The radio relay device 200 inserts the subframe that stores the identifier 2 to a subsequent subframe SF2 of the subframe SF1 being transmitted at time TC23.

The radio control device 100 receives the measurement response frame F21. The radio control device 100 receives the subframe that stores the identifier 1 at time TC14 and receives the subframe that stores the identifier 2 at time TC24.

The subframe that stores the identifier 1 is transmitted at time TC10 and is received at time TC14. Therefore, the time difference between time TC14 and time TC10 is the frame transmission/reception time difference of the radio relay device 200 of the identifier 1.

The subframe that stores the identifier 2 is transmitted at time TC20 and is received at time TC24. Therefore, the time difference between time TC24 and time TC20 is the frame transmission/reception time difference of the radio device 300-1 of the identifier 2.

<Arrival Period Measurement Process>

A process of measuring the arrival period of each device based on the measured frame transmission/reception time difference of each device will be described.

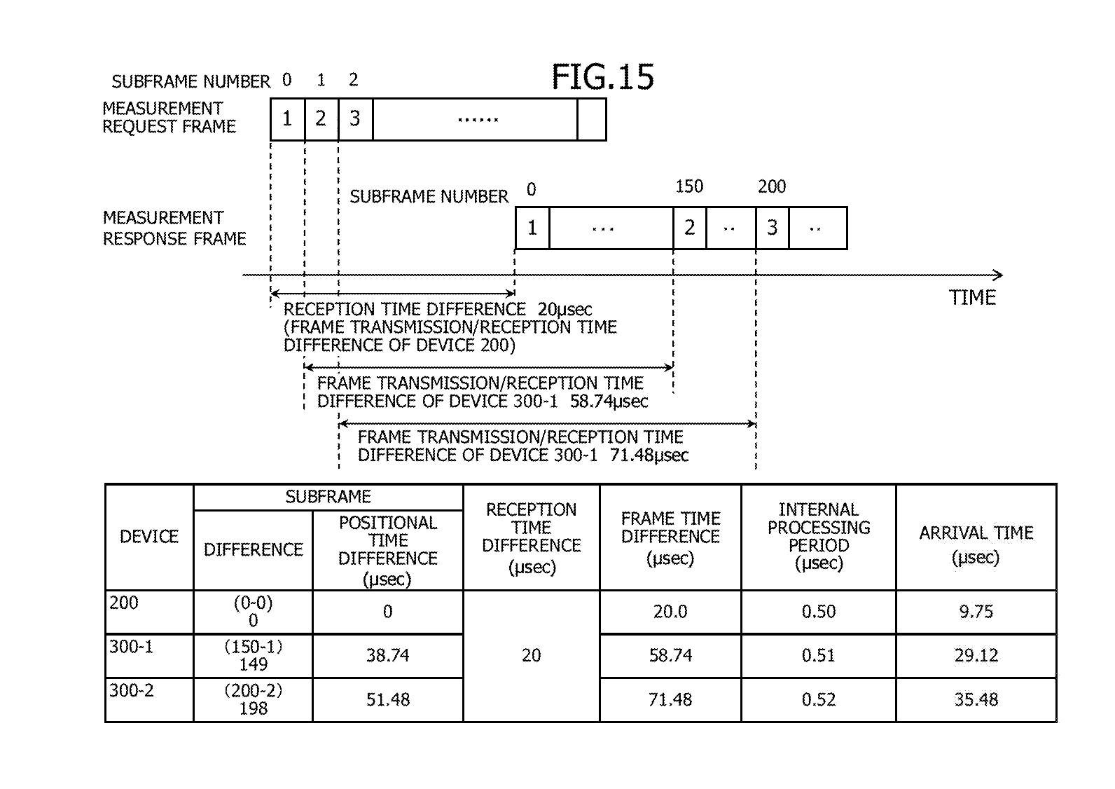

FIG. 15 is a diagram illustrating an example of an arrival period calculation result. Examples of the measurement request frame transmitted by the radio control device 100 and the measurement response frame received by the radio control device 100 are illustrated on the upper side of FIG. 15, and an example of an arrival period calculation result is illustrated on the lower side of FIG. 15.

The radio control device 100 transmits the measurement request frame in which the identifier 1 of the radio relay device 200 is stored in the subframe 0, the identifier 2 of the radio device 300-1 is stored in the subframe 1, and the identifier 3 of the radio device 300-2 is stored in the subframe 3. The radio control device 100 receives the measurement response frame after the elapse of 20 μsec from the start of transmission of the measurement request frame. The measurement response frame has a subframe in which the identifier 1 is stored in the subframe 0, the identifier 2 is stored in the subframe 150, and the identifier 3 is stored in the subframe 200. Hereinafter, an arrival period calculation process will be described using the radio device 300-1 (the identifier 2) as an example.

The radio control device 100 detects the frame transmission/reception time difference of the radio device 300-1 in order to measure the arrival period of the radio device 300-1. The frame transmission/reception time difference is calculated based on a transmission/reception time difference indicating a time difference between the transmission start time of the measurement request frame and the reception start time of the measurement response frame and a difference in the position in a subframe in which the identifiers 2 included in the measurement request frame and the measurement response frame are stored. The difference in the position within the frame is a difference in the subframe number indicating the order of a subframe from the starting subframe in the frame. The radio control device 100 detects the sum of the transmission/reception time difference and a positional time difference obtained by multiplying the time length of a subframe and the difference in the position of the subframe as the frame transmission/reception time difference.

The position of the subframe that stores the identifier 2 is the subframe 1 for the measurement request frame and the subframe 150 for the measurement response frame. Therefore, the difference in the position of the subframe is 149 (=150−1). Furthermore, the positional time difference is calculated as 38.74 μsec (=149×0.26) by multiplying the time length (0.26 μsec) of the subframe and the difference (149) in the position of the subframe.

Since the sum of the positional time difference and the transmission/reception time difference is the frame transmission/reception time difference, the frame transmission/reception time difference is 58.74 μsec (=38.75+20). The frame transmission/reception time difference includes an internal processing period taken for preparing for generating the measurement response frame and transmitting the generated measurement response frame. Therefore, a period obtained by subtracting the internal processing period from the detected frame transmission/reception time difference is a period taken for transmitting and receiving a frame between the radio control device 100 and the radio device 300-1 (that is, a delay on a transmission route for transmission/reception of frames). The radio control device 100 calculates a period obtained by dividing the delay by 2 as the arrival period by assuming that the period taken for transmission and reception of a frame is equal regardless of a transmission direction. Therefore, the arrival period is calculated as 29.12 μsec (=(58.74-0.51)/2) by subtracting the internal processing period (0.51 μsec) from the frame transmission/reception time difference (58.74 μsec) and dividing the subtracted numerical value by 2.

The radio control device 100 calculates the arrival periods of the respective devices in a similar manner and stores the arrival period in the arrival period 1233 of the connected device information table 123. The radio control device 100 controls the radio wave transmission timings of the radio relay device 200 and the radio devices 300-1 and 300-2 based on the calculated arrival periods of the respective devices.

Control of radio wave transmission timings is executed by instructing each device so that each device starts transmitting data after a predetermined waiting period after each device receives the data to be transmitted as radio waves. The radio control device 100 determines a waiting period of each device based on a maximum arrival period which is the largest among the calculated arrival periods. In the case of FIG. 15, the maximum arrival period is 35.48 μsec of the radio device 300-2. The radio control device 100 determines a value (for example, 40.00 μsec) obtained, for example, by adding a period in which an error may occur to the maximum arrival period 35.48 μsec as the maximum delay which is a period elapsed until each device transmits a received frame as radio waves after the radio control device 100 transmits the frame. A period obtained by subtracting the arrival period from the maximum delay is a period (waiting period) elapsed until each device transmits a frame as radio waves after each device receives the frame. Each device can be synchronized with the radio wave transmission timing of the other device by adjusting the radio wave transmission timing so that each device transmits radio waves when a waiting period of the subject device is elapsed after the device receives a frame. For example, when the maximum delay is 40.00 μsec, the waiting period of the radio device 300-1 is 10.88 μsec (=40.00-29.12). The radio device 300-1 adjusts the radio wave transmission timing so that radio waves are transmitted after the elapse of 10.88 μsec after the radio device receives a frame. The radio control device 100 transmits a frame having a subframe that stores information on the waiting period of each device to each device whereby each device acquires the waiting period of the subject device.

In the first embodiment, the radio control device transmits one measurement request frame having a subframe that stores the identifiers of the radio relay device and the radio device. Moreover, the radio relay device having received the measurement request frame transmits the received measurement request frame to a plurality of subordinate radio devices. In response to reception of the subframe that stores the identifier of the subject device, included in the measurement request frame, the radio relay device and the radio devices send a measurement response frame having the subframe that stores the identifiers of the subject devices. Furthermore, the radio relay device inserts the subframe that stores the identifier of the subordinate radio device to the measurement response frame being transmitted according to the reception timing of the subframe that stores the identifier of the subordinate radio device. By doing so, the radio control device can measure the frame transmission/reception time differences of the radio relay device and the plurality of radio devices connected thereto by executing transmission of one measurement request frame once.

### Second Embodiment

A second embodiment will be described. In the second embodiment, route information indicating a radio relay device and a plurality of radio devices via which a measurement request frame is transmitted is stored in a subframe that stores the identifier of each device, and a frame transmission/reception time difference is detected for each route from the radio control device to the plurality of radio devices and the radio relay device.

<Configuration Example of Base Station System>

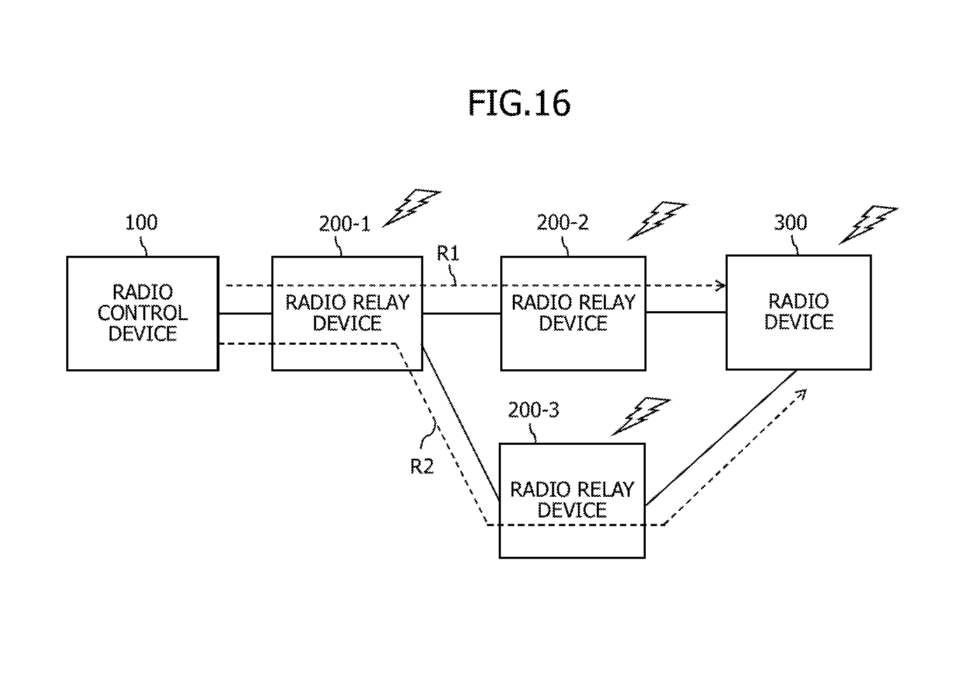

FIG. 16 is a diagram illustrating a configuration example of the base station system 10. The base station system 10 includes a radio control device 100, radio relay devices 200-1 to 200-3, and a radio device 300. The radio control device 100 is connected to the radio relay device 200-1 via an optical cable. Moreover, the radio relay device 200-1 is connected to the radio relay devices 200-2 and 200-3 via an optical cable. Furthermore, the radio relay devices 200-2 and 200-3 are connected to the radio device 300 via an optical cable.

The radio control device 100 transmits and receives frames to and from the radio device 300 using a communication route R1 that passes through the radio relay devices 200-1 and 200-2 or a communication route R2 that passes through the radio relay devices 200-1 and 200-3. For example, the communication route R1 is used for general communication, and the communication route R1 is switched to the communication route R2 when a fault occurs in the radio relay device 200-2, for example. The radio control device 100 controls the radio wave transmission timing of each device based on an arrival period in the communication route used for general communication.

<Frame Transmission/Reception Time Difference Measurement Process>

Hereinafter, a frame transmission/reception time difference measurement process will be described.

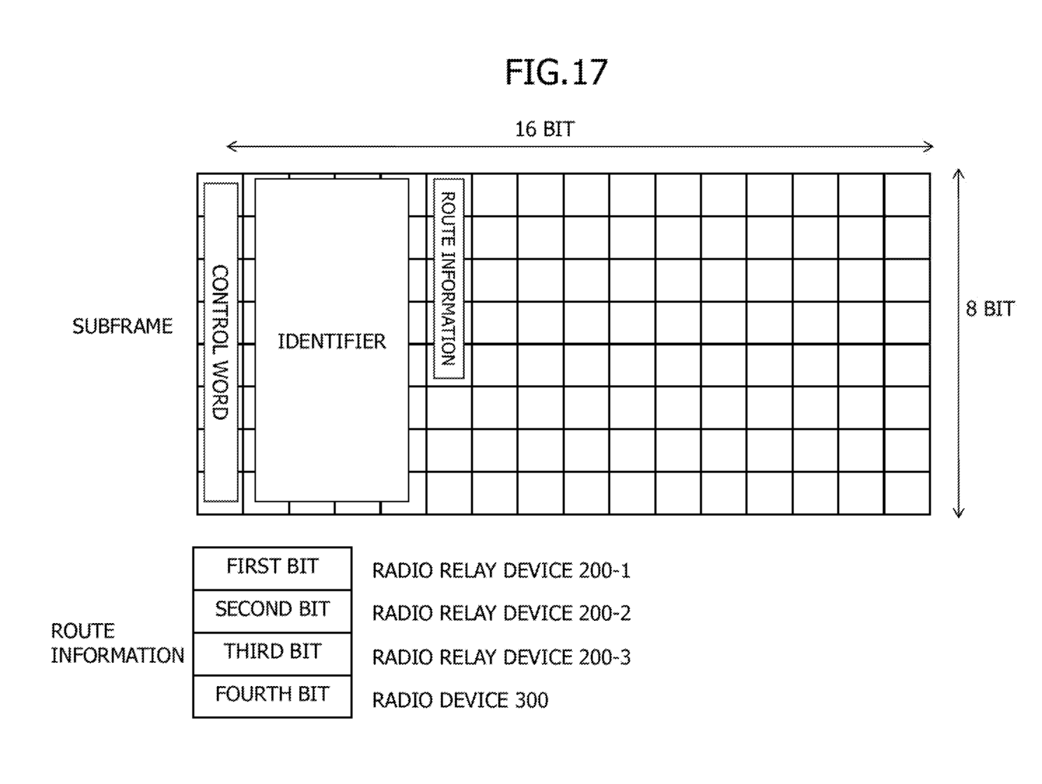

FIG. 17 is a diagram illustrating an example of a subframe used for measuring a frame period. A subframe stores 4-bit route information in addition to the identifier of each device. Each bit of the route information corresponds to each device, and a device through which the measurement request frame has passed sets the bit corresponding to the subject device to ON. The route information is stored in correlation with the identifier. In FIG. 17, although one identifier is correlated with one item of route information, when a plurality of identifiers is stored in one subframe, the same number of items of route information as the number of identifiers are stored.

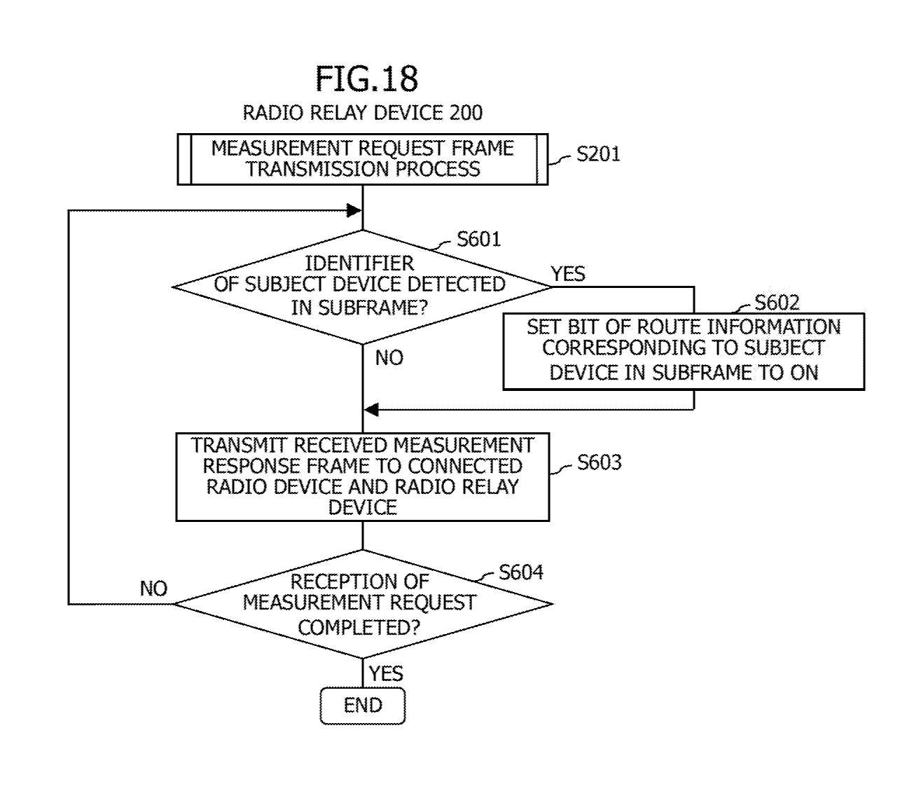

FIG. 18 is a diagram illustrating an example of a processing flow of the measurement response frame transmission process of the radio relay device 200. In the measurement response frame transmission process of the first embodiment, the received measurement request frame is transmitted to the connected radio device and radio relay device without changing the data. In the measurement response frame transmission process of the second embodiment, when the identifier of the other device is detected in the subframe (S601: Yes), the bit of the route information corresponding to the subject device in the subframe is set to ON (S602) and the received measurement response frame to the connected radio device and radio relay device (S603). When the identifier of the other device is not detected in the subframe (S601: Yes), the received measurement response frame is transmitted to the connected radio device and radio relay device without updating the data (S603). After that, the processes S601 to S603 are repeated until reception of the measurement request frame is completed (S604: Yes).

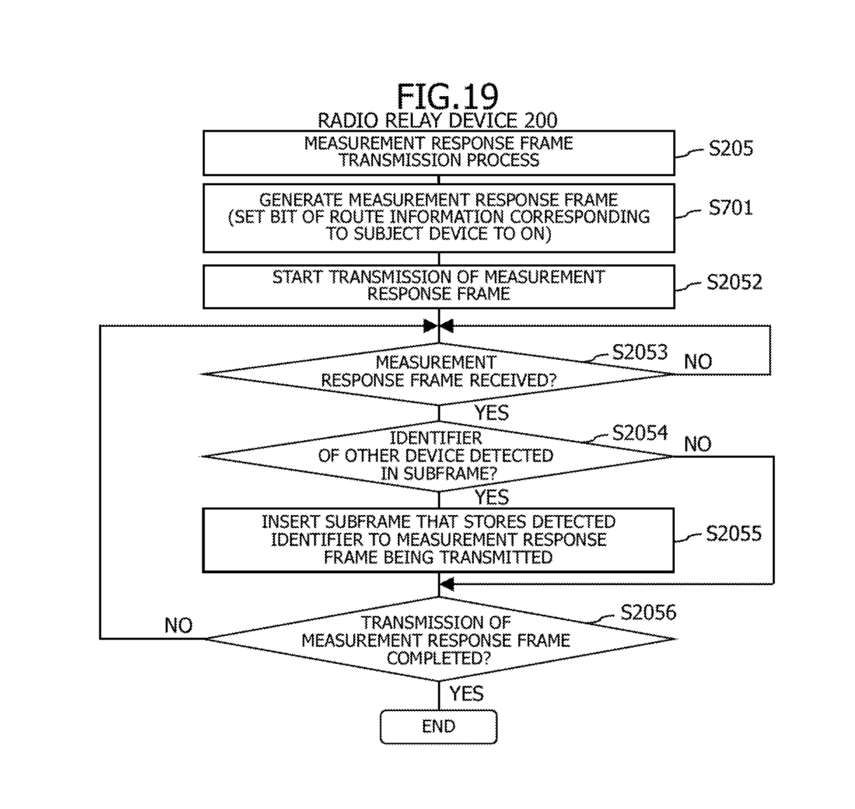

FIG. 19 is a diagram illustrating an example of a processing flow of the measurement response frame transmission process of the radio relay device 200. Process S701 is different from the measurement response frame transmission process of the first embodiment. The radio relay device 200 sets the bit of the route information corresponding to the subject device to ON when generating the measurement response frame (S701).

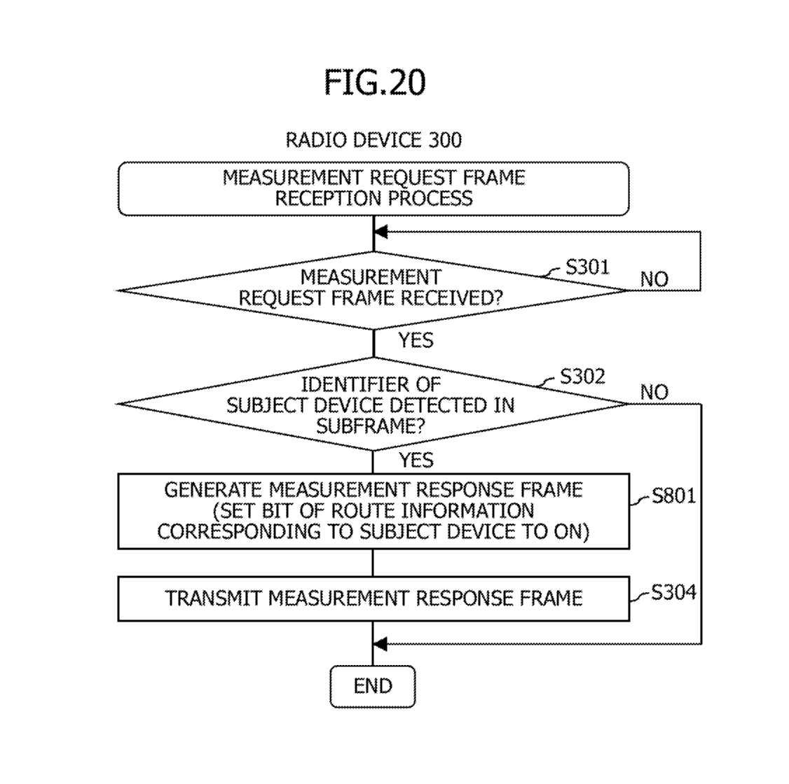

FIG. 20 is a diagram illustrating an example of a processing flow of the measurement request frame reception process of the radio device 300. Process S801 is different from the measurement request frame reception process of the first embodiment. The radio device 300 sets the bit of the route information corresponding to the subject device to ON when generating the measurement response frame (S801). In this manner, the radio relay device and the radio device sets the bit of the route information corresponding to the subject device to ON when transmitting the measurement request frame and generating the measurement response frame to notify the radio control device of the fact that the measurement request frame has passed through the subject device.

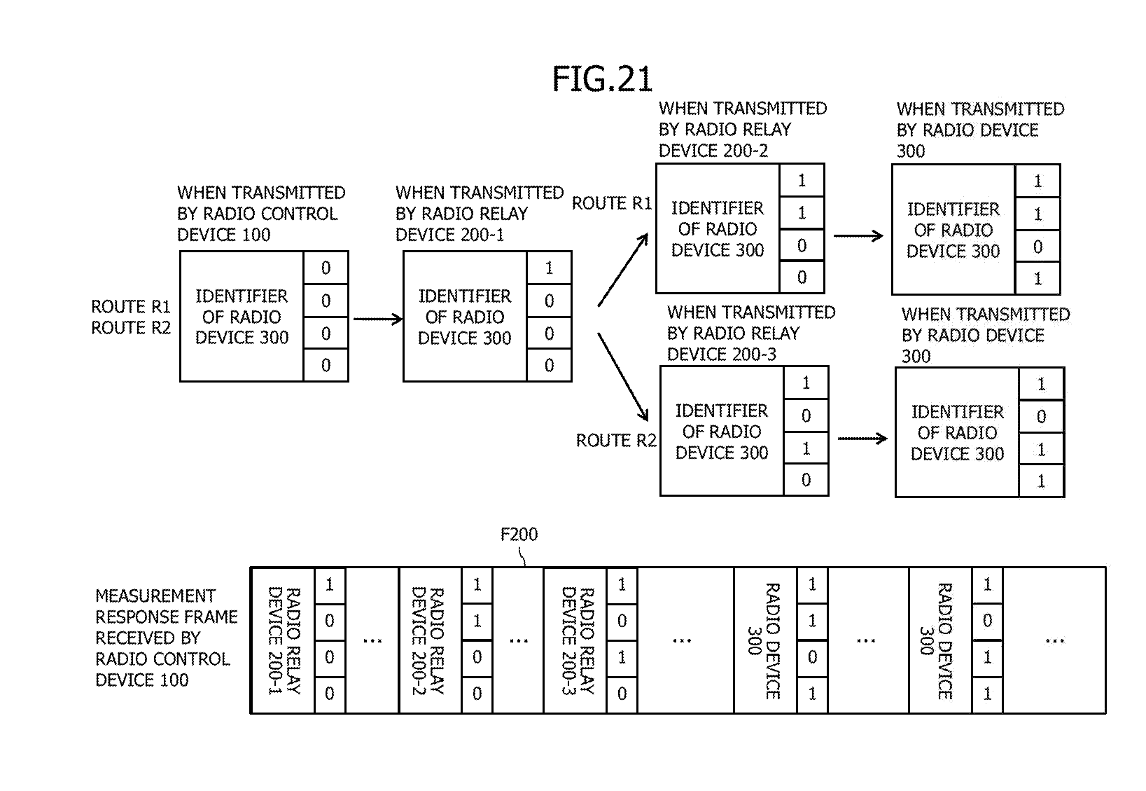

FIG. 21 is a diagram illustrating an example of transition of route information for each communication route. Examples of route information allocated to the identifier of the radio device 300 when the measurement request frame is transmitted to each device are illustrated on the upper side of FIG. 21 for each of the routes R1 and R2. An example of the measurement response frame that the radio control device 100 receives is illustrated on the lower side of FIG. 21.

The radio control device 100 transmits a measurement request frame to the radio relay device 200-1. In this case, the route information allocated to the identifier of the radio device 300 is “0000” (each digit represents a first bit, a second bit, a third bit, and a fourth bit from left to right; the same herein below).

Upon receiving the measurement request frame, the radio relay device 200-1 sets the first bit which is the bit corresponding to the subject device, of the route information allocated to the identifier of the radio device 300 to ON and transmits the measurement request frame having the route information “1000” to the radio relay devices 200-2 and 200-3.

When the measurement request frame is transmitted via the route R1, the measurement request frame is transmitted to the radio relay device 200-2. Upon receiving the measurement request frame, the radio relay device 200-2 sets the second bit which is the bit corresponding to the subject device, of the route information allocated to the identifier of the radio device 300 to ON and transmits the measurement request frame having the route information “1100” to the radio device 300. The radio device 300 receives the measurement request frame, sets the fourth bit which is the bit corresponding to the subject device, of the route information allocated to the identifier of the radio device 300 to ON, generates the measurement response frame having the route information “1101,” and sends the generated measurement response frame to the radio control device 100.

On the other hand, when the measurement request frame is transmitted via the route R2, the measurement request frame is transmitted to the radio relay device 200-3. Upon receiving the measurement request frame, the radio relay device 200-3 sets the third bit which is the bit corresponding to the subject device, of the route information allocated to the identifier of the radio device 300 to ON, and transmits the measurement request frame having the route information “1010” to the radio device 300. The radio device 300 receives the measurement request frame, sets the fourth bit which is the bit corresponding to the subject device, of the route information allocated to the identifier of the radio device 300 to ON, generates the measurement response frame having the route information “1011,” and sends the generated measurement response frame to the radio control device 100.

The radio control device 100 receives the measurement response frame F200. Two subframes that store the identifier of the radio device 300 are present in the measurement response frame F200. One of the items of the route information allocated to the identifier of the radio device 300 is “1101” and the other is “1011”. From this route information, the radio control device 100 can determine that the respective subframes have passed through separate routes even when the identifiers are the same. When a number of the same identifiers are present, the radio control device 100 detects the frame transmission/reception time difference of each communication route and measures the arrival period.

In the first embodiment, the radio relay device transmits the measurement request frame to all destination radio devices and radio relay device. Moreover, the radio relay device and the radio devices send a measurement response frame in response to reception of the subframe that stores the identifier of the subject device, included in the measurement request frame. Therefore, when the process of the first embodiment is applied to the base station system having a plurality of transmission/reception routes illustrated in FIG. 16, the radio control device receives a measurement response frame in which a number of subframes that store the identifier of the radio device 300, corresponding to the number of transmission/reception routes are included. As a result, the radio control device cannot determine which communication route the respective subframes have passed through.

Therefore, in the second embodiment, an identifier is allocated to route information. By doing so, even when a plurality of subframes that store the same identifier are present in a measurement response frame, it is possible to determine the communication routes of the respective subframes and to measure the frame transmission/reception time difference of each communication route.

### Other Embodiments

The other embodiments will be described. The respective processes of the first and second embodiments can be applied to a configuration other than the configuration of the base station system according to the first and second embodiments.

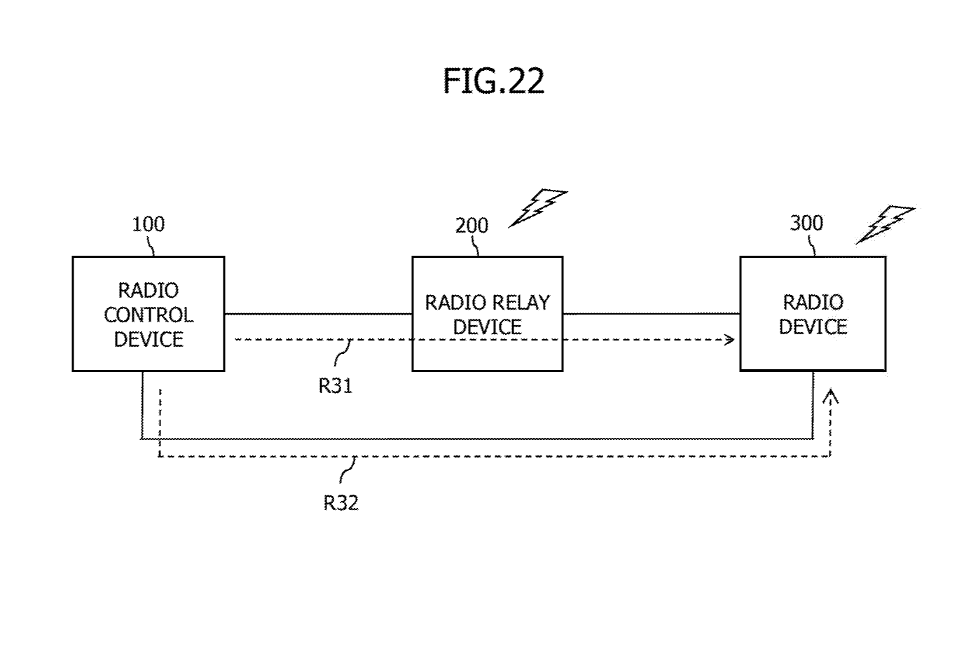

FIG. 22 is a diagram illustrating a configuration example of a base station system. The base station system illustrated in FIG. 22 has a Ring-type configuration, for example, which includes a route R32 to which the radio control device 100 and the radio device 300 are directly connected and a route R31 connected via the radio relay device 200. In the configuration illustrated in FIG. 22, the radio control device 100 transmits a measurement request frame to both the routes R31 and R32. A measurement request frame having a subframe that stores the identifiers of the radio relay device 200 and the radio device 300 is transmitted to the route R31, and a measurement request frame having a subframe that stores the identifier of the radio device 300 is transmitted to the route R32. Since the routes R31 and R32 are connected by different optical cables, it is possible to transmit the measurement request frames to both routes simultaneously and to receive measurement response frames.

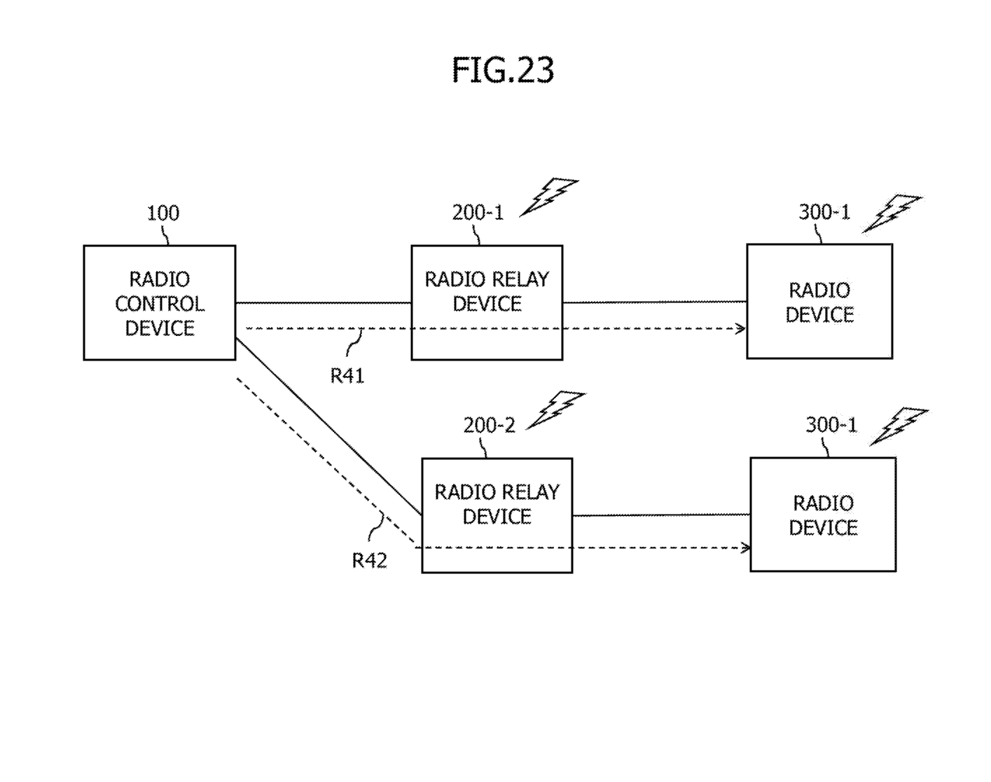

FIG. 23 is a diagram illustrating a configuration example of a base station system. The base station system illustrated in FIG. 23 has a Star-type configuration, for example, in which the radio control device 100 is connected to a plurality of radio relay devices 200-1 and 200-2. In the configuration illustrated in FIG. 23, the radio control device 100 transmits a measurement request frame to both routes R41 and R42. A measurement request frame having a subframe that stores the identifiers of the radio relay device 200-1 and the radio device 300-1 is transmitted to the route R41, and a measurement request frame having a subframe that stores the identifiers of the radio relay device 200-2 and the radio device 300-2 is transmitted to the route R42. Since the routes R41 and R42 are connected by different optical cables, it is possible to transmit the measurement request frames to both routes simultaneously and to receive measurement response frames.

Although the radio relay devices 200-1 and 200-2 in FIG. 23 are connected to the radio devices 300-1 and 300-2 singly, the radio relay devices may be connected to a plurality of radio devices. A configuration in which a plurality of radio devices is connected to one radio relay device is referred to as a Tree-type configuration, for example. The base station system illustrated in FIG. 1 has a Tree-type configuration.

The processes of the first and second embodiments can be applied to the base station systems having the Ring, Star, and Tree-type configurations. Moreover, although not illustrated in the drawings, the processes may be applied to a base station system having a configuration in which the Ring, Star, and Tree-type configurations are combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A radio control device which is connected to a plurality of radio devices via a radio relay device, the radio control device comprising:
a transmission unit that transmits, to the radio relay device, a first frame which has a plurality of subframes each having a fixed time length, the plurality of subframes including one or more subframes that store respective identifiers of the plurality of radio devices and the radio relay device;
a reception unit that receives a second frame which has one or more subframes that store the identifiers of the plurality of radio devices and the radio relay device from the radio relay device; and
a detection unit that detects a time difference between a transmission time point of the subframe that stores the identifiers of the respective devices in the first frame and a reception time point of the subframe that stores the identifiers of the respective devices in the second frame received, wherein
the subframe that stores the identifiers of the respective devices, included in the second frame, includes:
a subframe that stores the identifier of the radio relay device that the radio relay device has inserted in the second frame in response to reception of the subframe that stores the identifier of the radio relay device in the first frame; and
a subframe that stores the identifier of the radio device that the radio relay device has inserted in the second frame at a timing corresponding to a reception timing of a subframe that stores the identifier of the radio device in a third frame, the third frame being sent by the radio device to the radio relay device in response to reception of the subframe that stores the identifier of a subject radio device in the first frame, and the third frame having the subframe that stores the identifier of the subject radio device.

2. The radio control device according to claim 1, wherein
the detection unit detects, as the time difference, a sum of a transmission/reception time difference, between a time point at which transmission of the first frame starts and a time point at which reception of the second frame starts, and a positional time difference calculated by multiplying the fixed time length by a difference in position within a frame between the subframe that stores the identifiers of the respective devices in the first frame and the subframe that stores the identifiers of the respective devices in the second frame.

3. The radio control device according to claim 2, wherein
the detection unit further calculates, as arrival periods taken for the first frame to arrive in the radio relay device and the plurality of radio devices, numerical values which are obtained by dividing by 2 numerical values that result from subtracting an internal processing period, which corresponds to a period taken for the radio relay device to transmit the second frame or to periods taken for the plurality of radio devices to transmit the third frame, from the time difference.

4. The radio control device according to claim 3, further comprising:
a communication control unit that selects a maximum arrival period which is the largest among the arrival periods calculated by the detection unit and controls timings at which the plurality of radio devices and the radio relay device transmit radio waves based on the selected maximum arrival period.

5. The radio control device according to claim 1, wherein
the timing corresponding to the reception timing of the subframe that stores the identifier of the radio device in the third frame is a timing at which a subframe transmitted subsequently to the subframe in the second frame, which is being transmitted when the radio relay device receives the subframe, is transmitted.

6. The radio control device according to claim 1, wherein
the second frame further includes a subframe that stores route information indicating a radio relay device via which the first frame has passed, and
the detection unit detects the time difference for each route from the radio control device to the plurality of radio devices and the radio relay device, based on the route information stored in the subframe in the received second frame.

7. A radio relay device which is connected to a plurality of radio devices and a radio control device, comprising:
a transmission unit that receives, from the radio control device, a first frame which has a plurality of subframes each having a fixed time length, the plurality of subframes including one or more subframes that store respective identifiers of the plurality of radio devices and the radio relay device; and
a responding unit that sends, to the radio control device, a second frame which has a subframe that includes the identifier of the radio relay device in response to reception of the subframe that stores the identifier of the radio relay device in the first frame, and inserts one or more subframes that store the identifier of the radio device to the second frame at a timing corresponding to a reception timing of the subframe that stores the identifier of the radio device in the third frame received from the radio device, wherein
the subframe that stores the identifier of the radio device in the third frame is a subframe included in the third frame that the radio device has sent to the radio relay device in response to reception of the subframe that stores the identifier of the radio device in the first frame.

8. The radio relay device according to claim 7, wherein
the timing corresponding to the reception timing of the subframe that stores the identifier of the radio device in the third frame is a timing at which a subframe transmitted subsequently to the subframe in the second frame, which is being transmitted when the subframe is received, is transmitted.

9. The radio relay device according to claim 7, wherein
the transmission unit inserts, to the first frame to be transmitted, a subframe that stores route information indicating that the first frame to be transmitted has passed through the subject device.

10. A detection method in a base station system including a radio relay device, a plurality of radio devices, and a radio control device connected to the plurality of radio devices via the radio relay device, the method comprising:
allowing the radio control device to transmit, to the radio relay device, a first frame which has a plurality of subframes having each a fixed time length, the plurality of subframes including one or more subframes that store respective identifiers of the plurality of radio devices and the radio relay device;
allowing the radio relay device to receive the first frame, transmit the first frame to the plurality of radio devices, and send a second frame having one or more subframes that store the identifier of the radio relay device, to the radio control device, in response to reception of the subframe that stores the identifier of the radio relay device included in the first frame;
allowing the radio device to send a third frame having a subframe that stores the identifier of a subject radio device, to the radio relay device, in response to reception of the subframe that stores the identifier of the subject radio device in the first frame;
allowing the radio relay device to insert a subframe that stores the identifier of the radio device to the second frame at a timing corresponding to a reception timing of the subframe that stores the identifier of the radio device included in the third frame; and
allowing the radio control device to detect a time difference between a transmission time point of the subframe that stores the identifiers of the respective devices in the first frame and a reception time point of the subframe that stores the identifiers of the respective devices in the second frame received.
